(19) United States
(12) Patent Application Publication
(10) Pub. No.: US 2026/0181354 A1
(43) Pub. Date: Jun. 25, 2026

(54) RF DEVICE POSITIONING IN A WIRELESS NETWORK

(71) Applicant: QUALCOMM Incorporated, San Diego, CA (US)

(72) Inventors: Zhikun WU, Beijing (CN); Ahmed ELSHAFIE, San Diego, CA (US); Yuchul KIM, San Diego, CA (US); Huilin XU, Temecula, CA (US); Wei YANG, San Diego, CA (US); Linhai HE, San Diego, CA (US)

(21) Appl. No.: 19/127,019

(22) PCT Filed: Jan. 13, 2023
(86) PCT No.: PCT/CN2023/071995

§ 371 Date: May 2, 2025

(51) Int. Cl. H04W 4/029; G06K 7/10

(52) U.S. Cl. CPC H04W 4/029; G06K 7/10366

(57) ABSTRACT

Techniques for determining a position of a radio frequency (RF) device within a wireless network are disclosed. In some embodiments, such techniques may involve receiving, at a first wireless device of the wireless network, a first positioning assist request from an RF reader configured to exchange data with the RF device; based on a determination to provide positioning assistance to the RF reader, conducting positioning of the RF device, the positioning of the RF device comprising: sending a second positioning assist request to a second wireless device of the wireless network, locating positioning resources, or a combination thereof; and based on the conducted positioning of the RF device, sending position information associated with the RF device to the RF reader.

### BACKGROUND

### 1. Field of Disclosure

The present disclosure relates generally to the field of wireless communications, and more specifically to, e.g., determining a position of a radio frequency (RF) device using one or more wireless devices within a wireless network.

### 2. Description of Related Art

There has been consistent interest in passive Internet of Things (IoT) technology for use in radio access technologies (RATs). They are capable of utilizing passive communication (or low-power communication) such as backscatter communication. In particular, zero-power IoT (ZP-IoT) communication using devices such as radio-frequency identification (RFID) tags often do not need an internal power source to operate. As such, zero-power technology can achieve low power requirements, small form factors (without battery and/or wearable), and low cost of devices. It is gaining traction as advantageous for uses such as process automation and facility automation within industrial wireless sensor networks, smart devices, smart homes, and medical information management.

### BRIEF SUMMARY

In one aspect of the present disclosure, a method of determining a position of a radio frequency (RF) device within a wireless network is disclosed. In some embodiments, the method includes: receiving, at a first wireless device of the wireless network, a first positioning assist request from an RF reader configured to exchange data with the RF device; based on a determination to provide positioning assistance to the RF reader, conducting positioning of the RF device, the positioning of the RF device comprising: sending a second positioning assist request to a second wireless device of the wireless network, locating positioning resources, or a combination thereof; and based on the conducted positioning of the RF device, sending position information associated with the RF device to the RF reader.

In some embodiments, the method includes: at an RF reader configured to receive data from the RF device: configuring a positioning assist request relating to the RF reader, a wireless device of the wireless network, the RF device, or a combination thereof; sending the positioning assist request to the wireless device of the wireless network; and receiving location information associated with the RF device from the wireless device based on the positioning assist request.

In another aspect of the present disclosure, a wireless device within a wireless network is disclosed. In some embodiments, the wireless device includes: one or more transceivers configured to communicate with a radio frequency (RF) reader and an RF device, the RF reader configured to exchange data with the RF device; memory; and one or more processors communicatively coupled to the one or more transceivers and the memory, and configured to: receive a first positioning assist request from the RF reader; based on a determination to provide positioning assistance to the RF reader, conduct positioning of the RF device, the positioning of the RF device comprising: sending a second positioning assist request to another wireless device of the wireless network, locating positioning resources, or a combination thereof; and based on the conducted positioning of the RF device, send position information associated with the RF device to the RF reader.

In another aspect of the present disclosure, a radio frequency (RF) reader is disclosed. In some embodiments, the RF reader includes: one or more transceivers configured to communicate with an RF device; memory; and one or more processors communicatively coupled to the one or more transceivers and the memory, and configured to: configure a positioning assist request relating to the RF reader, a wireless device of a wireless network, the RF device, or a combination thereof; send the positioning assist request to the wireless device of the wireless network; and receive location information associated with the RF device from the wireless device based on the positioning assist request.

In another aspect of the present disclosure, a non-transitory computer-readable apparatus is disclosed. In some embodiments, the non-transitory computer-readable apparatus includes a storage medium, the storage medium comprising a plurality of instructions configured to, when executed by one or more processors, cause an apparatus to: receive, at a first wireless device of the wireless network, a first positioning assist request from an RF reader configured to exchange data with the RF device; based on a determination to provide positioning assistance to the RF reader, conduct positioning of the RF device, the positioning of the RF device comprising: sending a second positioning assist request to a second wireless device of the wireless network, locating positioning resources, or a combination thereof; and based on the conducted positioning of the RF device, send position information associated with the RF device to the RF reader.

In some embodiments, the non-transitory computer-readable apparatus includes a storage medium, the storage medium comprising a plurality of instructions configured to, when executed by one or more processors, cause a radio frequency (RF) reader configured to receive data from an RF device to: configure a positioning assist request relating to the RF reader, a wireless device of the wireless network, the RF device, or a combination thereof; send the positioning assist request to the wireless device of the wireless network; and receive location information associated with the RF device from the wireless device based on the positioning assist request.

In another aspect of the present disclosure, an apparatus is disclosed. In some embodiments, the apparatus includes: means for receiving, at a first wireless device of the wireless network, a first positioning assist request from an RF reader configured to exchange data with the RF device; means for, based on a determination to provide positioning assistance to the RF reader, conducting positioning of the RF device, the positioning of the RF device comprising: sending a second positioning assist request to a second wireless device of the wireless network, locating positioning resources, or a combination thereof; and means for, based on the conducted positioning of the RF device, sending position information associated with the RF device to the RF reader.

In some embodiments, the apparatus includes: means for configuring a positioning assist request relating to the RF reader, a wireless device of the wireless network, the RF device, or a combination thereof; means for sending the positioning assist request to the wireless device of the wireless network; and means for receiving location information associated with the RF device from the wireless device based on the positioning assist request.

This summary is neither intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

FIG. 1 is a diagram of a positioning system, according to an embodiment.

FIG. 2 is a diagram of a 5th Generation (5G) New Radio (NR) positioning system, illustrating an embodiment of a positioning system (e.g., the positioning system of FIG. 1) implemented within a 5G NR communication network.

FIGS. 3A and 3B are illustrations of radio frequency (RF) readers and tags that form a simple communication system using backscattered RF signals.

FIGS. 4A and 4B illustrate simplified diagrams of example zero-power Internet of Things (ZP-IoT) systems with and without a relay device, useful for implementing embodiments disclosed herein.

FIG. 5 shows an example positioning scheme with an RF reader and an RF device.

FIG. 6 shows an example positioning scheme with an RF reader, one or more assistant UEs, and an RF device.

FIG. 7A is an example embodiment of an RF reader sending a positioning assist request to a base station.

FIG. 7B is an example embodiment of an RF reader sending a positioning assist request to a UE.

FIG. 7C is another example embodiment of an RF reader sending a positioning assist request to a base station.

FIG. 8 is a signaling flow diagram between an RF reader and a nearby assistant UE, according to some embodiments.

FIG. 9 is a signaling flow diagram among an RF reader, a base station, and an assistant UE, according to some embodiments.

FIG. 10 is a flow diagram of a method of determining a position of an RF device within a wireless network, according to some embodiments.

FIG. 11 is a flow diagram of another method of determining a position of an RF device within a wireless network, according to some embodiments.

FIG. 12 is a block diagram of an embodiment of a UE, which can be utilized in embodiments as described herein.

FIG. 13 is a block diagram of an embodiment of a base station, which can be utilized in embodiments as described herein.

FIG. 14 is a block diagram of an embodiment of a computer system (e.g., an RF reader), which can be utilized in embodiments as described herein.

Like reference symbols in the various drawings indicate like elements, in accordance with certain example implementations. In addition, multiple instances of an element may be indicated by following a first number for the element with a letter or a hyphen and a second number. For example, multiple instances of an element 110 may be indicated as 110-1, 110-2, 110-3 etc. or as 110a, 110b, 110c, etc. When referring to such an element using only the first number, any instance of the element is to be understood (e.g., element 110 in the previous example would refer to elements 110-1, 110-2, and 110-3 or to elements 110a, 110b, and 110c).

### DETAILED DESCRIPTION

The following description is directed to certain implementations for the purposes of describing innovative aspects of various embodiments. However, a person having ordinary skill in the art will readily recognize that the teachings herein can be applied in a multitude of different ways. The described implementations may be implemented in any device, system, or network that is capable of transmitting and receiving radio frequency (RF) signals according to any communication standard, such as any of the Institute of Electrical and Electronics Engineers (IEEE) 802.15.4 standards for ultra-wideband (UWB), IEEE 802.11 standards (including those identified as Wi-Fi® technologies), the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Rate Packet Data (HRPD), High Speed Packet Access (HSPA), High Speed Downlink Packet Access (HSDPA), High Speed Uplink Packet Access (HSUPA), Evolved High Speed Packet Access (HSPA+), Long Term Evolution (LTE), Advanced Mobile Phone System (AMPS), or other known signals that are used to communicate within a wireless, cellular or internet of things (IoT) network, such as a system utilizing 3G, 4G, 5G, 6G, or further implementations thereof, technology.

As used herein, an “RF signal” comprises an electromagnetic wave that transports information through the space between a transmitter (or transmitting device) and a receiver (or receiving device). As used herein, a transmitter may transmit a single “RF signal” or multiple “RF signals” to a receiver. However, the receiver may receive multiple “RF signals” corresponding to each transmitted RF signal due to the propagation characteristics of RF signals through multiple channels or paths.

Additionally, unless otherwise specified, references to “reference signals,” “positioning reference signals,” “reference signals for positioning,” and the like may be used to refer to signals used for positioning of a user equipment (UE). As described in more detail herein, such signals may comprise any of a variety of signal types but may not necessarily be limited to a Positioning Reference Signal (PRS) as defined in relevant wireless standards.

Further, unless otherwise specified, the term “positioning” as used herein may absolute location determination, relative location determination, ranging, or a combination thereof. Such positioning may include and/or be based on timing, angular, phase, or power measurements, or a combination thereof (which may include RF sensing measurements) for the purpose of location or sensing services.

In some legacy communication systems, radio-frequency identification (RFID) systems using passive RF devices such as RFID tags are mature and widely used. However, current RFID systems are not natively compatible with incipient RATs, such as 5G New Radio (NR) systems. As an example, while current RFID systems can work within industrial, scientific and medical (ISM) bands, NR systems mainly work in licensed bands. That said, RFID functions may be used in conjunction with NR systems.

Thus, a new topology between current RFID systems and some non-legacy RATs (such as 5G NR systems) would be advantageous and useful. In some example implementations of RFID systems with modern RATs, the position of a RF device such as an RFID tag may be determined, e.g., so that an RF reader may interact with it. To this end, a different type of communication or communication paths may be used rather than the currently used backscatter communication. Additional details will follow after an initial description of relevant systems and technologies.

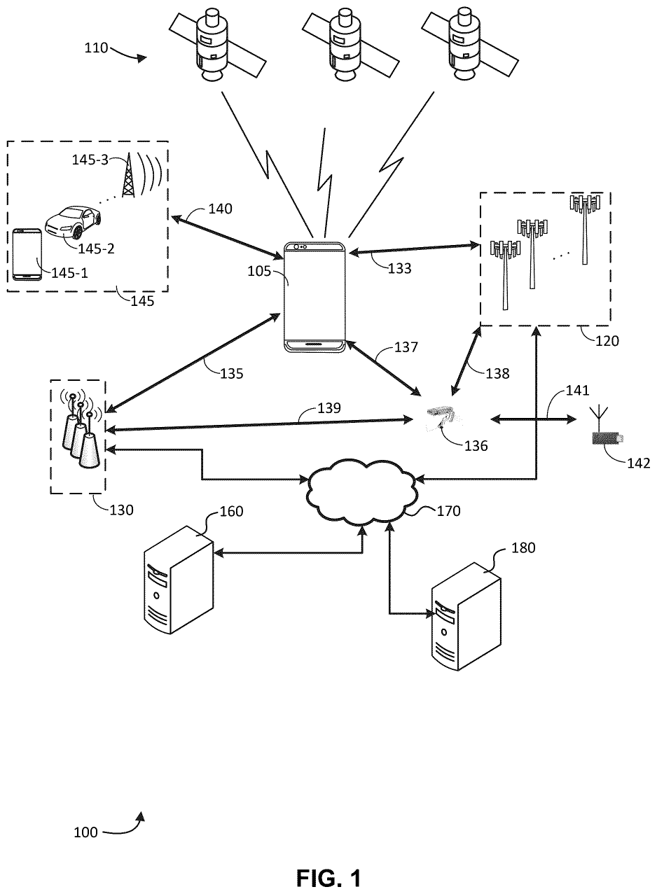

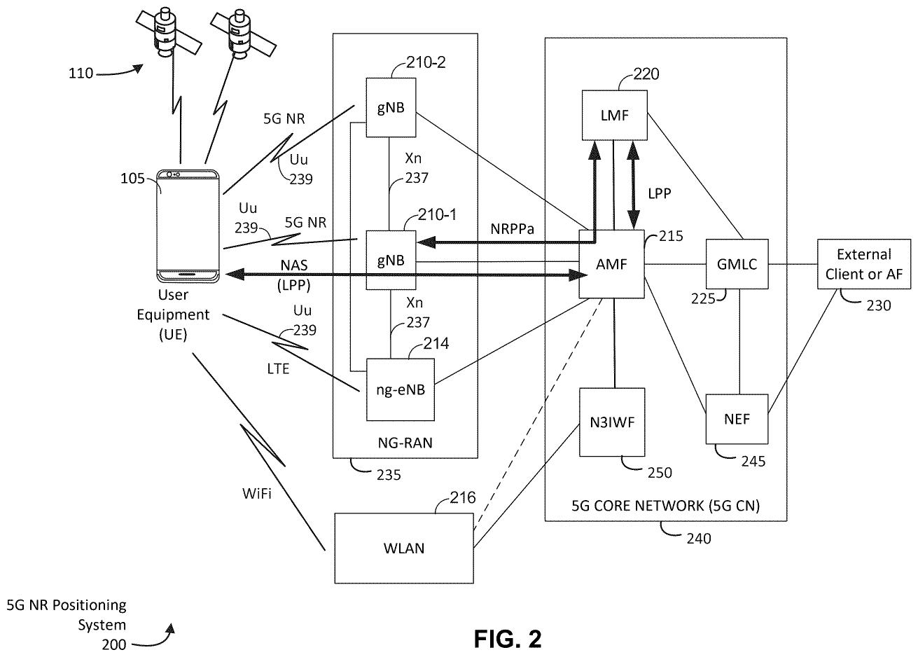

FIG. 1 is a simplified illustration of a positioning system 100 in which a UE 105, location server 160, and/or other components of the positioning system 100 can use the techniques provided herein for determining a position of a radio frequency (RF) device (using, e.g., UE 105 and/or base station 120), according to embodiments discussed herein. The techniques described herein may be implemented by one or more components of the positioning system 100. The positioning system 100 can include: a UE 105; one or more satellites 110 (also referred to as space vehicles (SVs)), which may include Global Navigation Satellite System (GNSS) satellites (e.g., satellites of the Global Positioning System (GPS), GLONASS, Galileo, Beidou, etc.) and/or Non-Terrestrial Network (NTN) satellites; base stations 120; access points (APs) 130; location server 160; network 170; and external client 180. Generally put, the positioning system 100 can estimate a location of the UE 105 based on RF signals received by and/or sent from the UE 105 and known locations of other components (e.g., GNSS satellites 110, base stations 120, APs 130) transmitting and/or receiving the RF signals. Additional details regarding particular location estimation techniques are discussed in more detail with regard to FIG. 2.

It should be noted that FIG. 1 provides only a generalized illustration of various components, any or all of which may be utilized as appropriate, and each of which may be duplicated as necessary. Specifically, although only one UE 105 is illustrated, it will be understood that many UEs (e.g., hundreds, thousands, millions, etc.) may utilize the positioning system 100. Similarly, the positioning system 100 may include a larger or smaller number of base stations 120 and/or APs 130 than illustrated in FIG. 1. The illustrated connections that connect the various components in the positioning system 100 comprise data and signaling connections which may include additional (intermediary) components, direct or indirect physical and/or wireless connections, and/or additional networks. Furthermore, components may be rearranged, combined, separated, substituted, and/or omitted, depending on desired functionality. In some embodiments, for example, the external client 180 may be directly connected to location server 160. A person of ordinary skill in the art will recognize many modifications to the components illustrated.

Depending on desired functionality, the network 170 may comprise any of a variety of wireless and/or wireline networks. The network 170 can, for example, comprise any combination of public and/or private networks, local and/or wide-area networks, and the like. Furthermore, the network 170 may utilize one or more wired and/or wireless communication technologies. In some embodiments, the network 170 may comprise a cellular or other mobile network, a wireless local area network (WLAN), a wireless wide-area network (WWAN), and/or the Internet, for example. Examples of network 170 include a Long-Term Evolution (LTE) wireless network, a Fifth Generation (5G) wireless network (also referred to as New Radio (NR) wireless network or 5G NR wireless network), a Wi-Fi WLAN, and the Internet. LTE, 5G and NR are wireless technologies defined, or being defined, by the 3rd Generation Partnership Project (3GPP). Network 170 may also include more than one network and/or more than one type of network.

The base stations 120 and access points (APs) 130 may be communicatively coupled to the network 170. In some embodiments, the base station 120s may be owned, maintained, and/or operated by a cellular network provider, and may employ any of a variety of wireless technologies, as described herein below. Depending on the technology of the network 170, a base station 120 may comprise a node B, an Evolved Node B (eNodeB or eNB), a base transceiver station (BTS), a radio base station (RBS), an NR NodeB (gNB), a Next Generation eNB (ng-eNB), or the like. A base station 120 that is a gNB or ng-eNB may be part of a Next Generation Radio Access Network (NG-RAN) which may connect to a 5G Core Network (5GC) in the case that Network 170 is a 5G network. The functionality performed by a base station 120 in earlier-generation networks (e.g., 3G and 4G) may be separated into different functional components (e.g., radio units (RUS), distributed units (DUs), and central units (CUs)) and layers (e.g., L1/L2/L3) in view Open Radio Access Networks (O-RAN) and/or Virtualized Radio Access Network (V-RAN or vRAN) in 5G or later networks, which may be executed on different devices at different locations connected, for example, via fronthaul, midhaul, and backhaul connections. As referred to herein, a “base station” (or ng-eNB, gNB, etc.) may include any or all of these functional components. An AP 130 may comprise a Wi-Fi AP or a Bluetooth® AP or an AP having cellular capabilities (e.g., 4G LTE and/or 5G NR), for example. Thus, UE 105 can send and receive information with network-connected devices, such as location server 160, by accessing the network 170 via a base station 120 using a first communication link 133. Additionally or alternatively, because APs 130 also may be communicatively coupled with the network 170, UE 105 may communicate with network-connected and Internet-connected devices, including location server 160, using a second communication link 135, or via one or more other mobile devices 145. Additionally, UE 105 can send and receive information with an RF reader (e.g., RFID reader) 136 via a third communication link 137. In some implementations, the third communication link 137 may utilize sidelink and/or similar Device-to-Device (D2D) communication technologies as described below. In some implementations, the third communication link 137 may utilize an IEEE 802.11 standard (including Wi-Fi), Bluetooth®, or another standardized communication technology. RF reader 136 may also be configured to communicate with UE 105 via the third communication link 137 and/or base station(s) 120 via a fourth communication link 138. In some implementations, the fourth communication link 138 may include a Uu interface (e.g., in LTE or NR) as described below. Downlink and uplink communications may be performed using the third and fourth communication links 137, 138. In addition, RF reader 136 may be configured to communicate with AP(s) 130 via a fifth communication link 139, which may utilize an IEEE 802.11 standard (including Wi-Fi), Bluetooth®, or another standardized communication technology (including cellular if capable). As will be further described below, the RF reader 136 may also be configured to interact with an RF device 142 (e.g., RFID tag or transponder). In some cases, the RF reader 136 may participate in zero-power IoT communication by emitting a carrier wave and receiving a backscattered wave, e.g., backscattered RF signals from the RF device 142 (e.g., an RFID tag) via communication link 141. In some cases, an active RF device may emit signals toward the RF reader 136, and the RF reader 136 may receive signals from the RF device.

As used herein, the term “base station” may generically refer to a single physical transmission point, or multiple co-located physical transmission points, which may be located at a base station 120. A Transmission Reception Point (TRP) (also known as transmit/receive point) corresponds to this type of transmission point, and the term “TRP” may be used interchangeably herein with the terms “gNB,” “ng-eNB,” and “base station.” In some cases, a base station 120 may comprise multiple TRPs—e.g. with each TRP associated with a different antenna or a different antenna array for the base station 120. As used herein, the transmission functionality of a TRP may be performed with a transmission point (TP) and/or the reception functionality of a TRP may be performed by a reception point (RP), which may be physically separate or distinct from a TP. That said, a TRP may comprise both a TP and an RP. Physical transmission points may comprise an array of antennas of a base station 120 (e.g., as in a Multiple Input-Multiple Output (MIMO) system and/or where the base station employs beamforming). The term “base station” may additionally refer to multiple non-co-located physical transmission points, the physical transmission points may be a Distributed Antenna System (DAS) (a network of spatially separated antennas connected to a common source via a transport medium) or a Remote Radio Head (RRH) (a remote base station connected to a serving base station).

As used herein, the term “cell” may generically refer to a logical communication entity used for communication with a base station 120, and may be associated with an identifier for distinguishing neighboring cells (e.g., a Physical Cell Identifier (PCID), a Virtual Cell Identifier (VCID)) operating via the same or a different carrier. In some examples, a carrier may support multiple cells, and different cells may be configured according to different protocol types (e.g., Machine-Type Communication (MTC), Narrowband Internet-of-Things (NB-IoT), Enhanced Mobile Broadband (eMBB), or others) that may provide access for different types of devices. In some cases, the term “cell” may refer to a portion of a geographic coverage area (e.g., a sector) over which the logical entity operates.

Satellites 110 may be utilized for positioning of the UE 105 in one or more ways. For example, satellites 110 (also referred to as space vehicles (SVs)) may be part of a Global Navigation Satellite System (GNSS) such as the Global Positioning System (GPS), GLONASS, Galileo or Beidou. Positioning using RF signals from GNSS satellites may comprise measuring multiple GNSS signals at a GNSS receiver of the UE 105 to perform code-based and/or carrier-based positioning, which can be highly accurate. Additionally or alternatively, satellites 110 may be utilized for NTN-based positioning, in which satellites 110 may functionally operate as TRPs (or TPs) of a network (e.g., LTE and/or NR network) and may be communicatively coupled with network 170. In particular, reference signals (e.g., PRS) transmitted by satellites 110 NTN-based positioning may be similar to those transmitted by base stations 120, and may be coordinated by a location server 160. In some embodiments, satellites 110 used for NTN-based positioning may be different than those used for GNSS-based positioning. In some embodiments NTN nodes may include non-terrestrial vehicles such as airplanes, balloons, drones, etc., which may be in addition or as an alternative to NTN satellites.

The location server 160 may comprise a server and/or other computing device configured to determine an estimated location of UE 105 and/or provide data (e.g., “assistance data”) to UE 105 to facilitate location measurement and/or location determination by UE 105. According to some embodiments, location server 160 may comprise a Home Secure User Plane Location (SUPL) Location Platform (H-SLP), which may support the SUPL user plane (UP) location solution defined by the Open Mobile Alliance (OMA) and may support location services for UE 105 based on subscription information for UE 105 stored in location server 160. In some embodiments, the location server 160 may comprise, a Discovered SLP (D-SLP) or an Emergency SLP (E-SLP). The location server 160 may also comprise an Enhanced Serving Mobile Location Center (E-SMLC) that supports location of UE 105 using a control plane (CP) location solution for LTE radio access by UE 105. The location server 160 may further comprise a Location Management Function (LMF) that supports location of UE 105 using a control plane (CP) location solution for NR or LTE radio access by UE 105.

In a CP location solution, signaling to control and manage the location of UE 105 may be exchanged between elements of network 170 and with UE 105 using existing network interfaces and protocols and as signaling from the perspective of network 170. In a UP location solution, signaling to control and manage the location of UE 105 may be exchanged between location server 160 and UE 105 as data (e.g. data transported using the Internet Protocol (IP) and/or Transmission Control Protocol (TCP)) from the perspective of network 170.

As previously noted (and discussed in more detail below), the estimated location of UE 105 may be based on measurements of RF signals sent from and/or received by the UE 105. In particular, these measurements can provide information regarding the relative distance and/or angle of the UE 105 from one or more components in the positioning system 100 (e.g., GNSS satellites 110, APs 130, base stations 120). The estimated location of the UE 105 can be estimated geometrically (e.g., using multiangulation and/or multilateration), based on the distance and/or angle measurements, along with known position of the one or more components.

Although terrestrial components such as APs 130 and base stations 120 may be fixed, embodiments are not so limited. Mobile components may be used. For example, in some embodiments, a location of the UE 105 may be estimated at least in part based on measurements of RF signals 140 communicated between the UE 105 and one or more other mobile devices 145, which may be mobile or fixed. As illustrated, other mobile devices may include, for example, a mobile phone 145-1, vehicle 145-2, static communication/positioning device 145-3, or other static and/or mobile device capable of providing wireless signals used for positioning the UE 105, or a combination thereof. Wireless signals from mobile devices 145 used for positioning of the UE 105 may comprise RF signals using, for example, Bluetooth® (including Bluetooth Low Energy (BLE)), IEEE 802.11x (e.g., Wi-Fi®), Ultra Wideband (UWB), IEEE 802.15x, or a combination thereof. Mobile devices 145 may additionally or alternatively use non-RF wireless signals for positioning of the UE 105, such as infrared signals or other optical technologies.

Mobile devices 145 may comprise other UEs communicatively coupled with a cellular or other mobile network (e.g., network 170). When one or more other mobile devices 145 comprising UEs are used in the position determination of a particular UE 105, the UE 105 for which the position is to be determined may be referred to as the “target UE,” and each of the other mobile devices 145 used may be referred to as an “anchor UE.” For position determination of a target UE, the respective positions of the one or more anchor UEs may be known and/or jointly determined with the target UE. Direct communication between the one or more other mobile devices 145 and UE 105 may comprise sidelink and/or similar Device-to-Device (D2D) communication technologies. Sidelink, which is defined by 3GPP, is a form of D2D communication under the cellular-based LTE and NR standards. UWB may be one such technology by which the positioning of a target device (e.g., UE 105) may be facilitated using measurements from one or more anchor devices (e.g., mobile devices 145).

According to some embodiments, such as when the UE 105 comprises and/or is incorporated into a vehicle, a form of D2D communication used by the mobile device 105 may comprise vehicle-to-everything (V2X) communication. V2X is a communication standard for vehicles and related entities to exchange information regarding a traffic environment. V2X can include vehicle-to-vehicle (V2V) communication between V2X-capable vehicles, vehicle-to-infrastructure (V2I) communication between the vehicle and infrastructure-based devices (commonly termed roadside units (RSUs)), vehicle-to-person (V2P) communication between vehicles and nearby people (pedestrians, cyclists, and other road users), and the like. Further, V2X can use any of a variety of wireless RF communication technologies. Cellular V2X (CV2X), for example, is a form of V2X that uses cellular-based communication such as LTE (4G), NR (5G) and/or other cellular technologies in a direct-communication mode as defined by 3GPP. The UE 105 illustrated in FIG. 1 may correspond to a component or device on a vehicle, RSU, or other V2X entity that is used to communicate V2X messages. In embodiments in which V2X is used, the static communication/positioning device 145-3 (which may correspond with an RSU) and/or the vehicle 145-2, therefore, may communicate with the UE 105 and may be used to determine the position of the UE 105 using techniques similar to those used by base stations 120 and/or APs 130 (e.g., using multiangulation and/or multilateration). It can be further noted that mobile devices 145 (which may include V2X devices), base stations 120, and/or APs 130 may be used together (e.g., in a WWAN positioning solution) to determine the position of the UE 105, according to some embodiments.

An estimated location of UE 105 can be used in a variety of applications-e.g. to assist direction finding or navigation for a user of UE 105 or to assist another user (e.g. associated with external client 180) to locate UE 105. A “location” is also referred to herein as a “location estimate”, “estimated location”, “location”, “position”, “position estimate”, “position fix”, “estimated position”, “location fix” or “fix”. The process of determining a location may be referred to as “positioning,” “position determination,” “location determination,” or the like. A location of UE 105 may comprise an absolute location of UE 105 (e.g. a latitude and longitude and possibly altitude) or a relative location of UE 105 (e.g. a location expressed as distances north or south, east or west and possibly above or below some other known fixed location (including, e.g., the location of a base station 120 or AP 130) or some other location such as a location for UE 105 at some known previous time, or a location of a mobile device 145 (e.g., another UE) at some known previous time). A location may be specified as a geodetic location comprising coordinates which may be absolute (e.g. latitude, longitude and optionally altitude), relative (e.g. relative to some known absolute location) or local (e.g. X, Y and optionally Z coordinates according to a coordinate system defined relative to a local area such a factory, warehouse, college campus, shopping mall, sports stadium or convention center). A location may instead be a civic location and may then comprise one or more of a street address (e.g. including names or labels for a country, state, county, city, road and/or street, and/or a road or street number), and/or a label or name for a place, building, portion of a building, floor of a building, and/or room inside a building etc. A location may further include an uncertainty or error indication, such as a horizontal and possibly vertical distance by which the location is expected to be in error or an indication of an area or volume (e.g. a circle or ellipse) within which UE 105 is expected to be located with some level of confidence (e.g. 95% confidence).

The external client 180 may be a web server or remote application that may have some association with UE 105 (e.g. may be accessed by a user of UE 105) or may be a server, application, or computer system providing a location service to some other user or users which may include obtaining and providing the location of UE 105 (e.g. to enable a service such as friend or relative finder, or child or pet location). Additionally or alternatively, the external client 180 may obtain and provide the location of UE 105 to an emergency services provider, government agency, etc.

As previously noted, the example positioning system 100 can be implemented using a wireless communication network, such as an LTE-based or 5G NR-based network. FIG. 2 shows a diagram of a 5G NR positioning system 200, illustrating an embodiment of a positioning system (e.g., positioning system 100) implementing 5G NR. The 5G NR positioning system 200 may be configured to determine the location of a UE 105 by using access nodes, which may include NR NodeB (gNB) 210-1 and 210-2 (collectively and generically referred to herein as gNBs 210), ng-eNB 214, and/or WLAN 216 to implement one or more positioning methods. The gNBs 210 and/or the ng-eNB 214 may correspond with base stations 120 of FIG. 1, and the WLAN 216 may correspond with one or more access points 130 of FIG. 1. Optionally, the 5G NR positioning system 200 additionally may be configured to determine the location of a UE 105 by using an LMF 220 (which may correspond with location server 160) to implement the one or more positioning methods. Here, the 5G NR positioning system 200 comprises a UE 105, and components of a 5G NR network comprising a Next Generation (NG) Radio Access Network (RAN) (NG-RAN) 235 and a 5G Core Network (5G CN) 240. A 5G network may also be referred to as an NR network; NG-RAN 235 may be referred to as a 5G RAN or as an NR RAN; and 5G CN 240 may be referred to as an NG Core network.

The 5G NR positioning system 200 may further utilize information from satellites 110. As previously indicated, satellites 110 may comprise GNSS satellites from a GNSS system like Global Positioning System (GPS) or similar system (e.g. GLONASS, Galileo, Beidou, Indian Regional Navigational Satellite System (IRNSS)). Additionally or alternatively, satellites 110 may comprise NTN satellites that may be communicatively coupled with the LMF 220 and may operatively function as a TRP (or TP) in the NG-RAN 235. As such, satellites 110 may be in communication with one or more gNB 210.

It should be noted that FIG. 2 provides only a generalized illustration of various components, any or all of which may be utilized as appropriate, and each of which may be duplicated or omitted as necessary. Specifically, although only one UE 105 is illustrated, it will be understood that many UEs (e.g., hundreds, thousands, millions, etc.) may utilize the 5G NR positioning system 200. Similarly, the 5G NR positioning system 200 may include a larger (or smaller) number of satellites 110, gNBs 210, ng-eNBs 214, Wireless Local Area Networks (WLANs) 216, Access and mobility Management Functions (AMF)s 215, external clients 230, and/or other components. The illustrated connections that connect the various components in the 5G NR positioning system 200 include data and signaling connections which may include additional (intermediary) components, direct or indirect physical and/or wireless connections, and/or additional networks. Furthermore, components may be rearranged, combined, separated, substituted, and/or omitted, depending on desired functionality.

The UE 105 may comprise and/or be referred to as a device, a mobile device, a wireless device, a mobile terminal, a terminal, a mobile station (MS), a Secure User Plane Location (SUPL)-Enabled Terminal (SET), or by some other name. Moreover, UE 105 may correspond to a cellphone, smartphone, laptop, tablet, personal data assistant (PDA), navigation device, Internet of Things (IoT) device, or some other portable or moveable device. Typically, though not necessarily, the UE 105 may support wireless communication using one or more Radio Access Technologies (RATs) such as using GSM, CDMA, W-CDMA, LTE, High Rate Packet Data (HRPD), IEEE 802.11 Wi-Fi®, Bluetooth, Worldwide Interoperability for Microwave Access (WiMAX™), 5G NR (e.g., using the NG-RAN 235 and 5G CN 240), etc. The UE 105 may also support wireless communication using a WLAN 216 which (like the one or more RATs, and as previously noted with respect to FIG. 1) may connect to other networks, such as the Internet. The use of one or more of these RATs may allow the UE 105 to communicate with an external client 230 (e.g., via elements of 5G CN 240 not shown in FIG. 2, or possibly via a Gateway Mobile Location Center (GMLC) 225) and/or allow the external client 230 to receive location information regarding the UE 105 (e.g., via the GMLC 225). The external client 230 of FIG. 2 may correspond to external client 180 of FIG. 1, as implemented in or communicatively coupled with a 5G NR network.

The UE 105 may include a single entity or may include multiple entities, such as in a personal area network where a user may employ audio, video and/or data I/O devices, and/or body sensors and a separate wireline or wireless modem. An estimate of a location of the UE 105 may be referred to as a location, location estimate, location fix, fix, position, position estimate, or position fix, and may be geodetic, thus providing location coordinates for the UE 105 (e.g., latitude and longitude), which may or may not include an altitude component (e.g., height above sea level, height above or depth below ground level, floor level or basement level). Alternatively, a location of the UE 105 may be expressed as a civic location (e.g., as a postal address or the designation of some point or small area in a building such as a particular room or floor). A location of the UE 105 may also be expressed as an area or volume (defined either geodetically or in civic form) within which the UE 105 is expected to be located with some probability or confidence level (e.g., 67%, 95%, etc.). A location of the UE 105 may further be a relative location comprising, for example, a distance and direction or relative X, Y (and Z) coordinates defined relative to some origin at a known location which may be defined geodetically, in civic terms, or by reference to a point, area, or volume indicated on a map, floor plan or building plan. In the description contained herein, the use of the term location may comprise any of these variants unless indicated otherwise. When computing the location of a UE, it is common to solve for local X, Y, and possibly Z coordinates and then, if needed, convert the local coordinates into absolute ones (e.g. for latitude, longitude and altitude above or below mean sea level).

Base stations in the NG-RAN 235 shown in FIG. 2 may correspond to base stations 120 in FIG. 1 and may include gNBs 210. Pairs of gNBs 210 in NG-RAN 235 may be connected to one another (e.g., directly as shown in FIG. 2 or indirectly via other gNBs 210). The communication interface between base stations (gNBs 210 and/or ng-eNB 214) may be referred to as an Xn interface 237. Access to the 5G network is provided to UE 105 via wireless communication between the UE 105 and one or more of the gNBs 210, which may provide wireless communications access to the 5G CN 240 on behalf of the UE 105 using 5G NR. The wireless interface between base stations (gNBs 210 and/or ng-eNB 214) and the UE 105 may be referred to as a Uu interface 239. 5G NR radio access may also be referred to as NR radio access or as 5G radio access. In FIG. 2, the serving gNB for UE 105 is assumed to be gNB 210-1, although other gNBs (e.g. gNB 210-2) may act as a serving gNB if UE 105 moves to another location or may act as a secondary gNB to provide additional throughput and bandwidth to UE 105.

Base stations in the NG-RAN 235 shown in FIG. 2 may also or instead include a next generation evolved Node B, also referred to as an ng-eNB, 214. Ng-eNB 214 may be connected to one or more gNBs 210 in NG-RAN 235-e.g. directly or indirectly via other gNBs 210 and/or other ng-eNBs. An ng-eNB 214 may provide LTE wireless access and/or evolved LTE (eLTE) wireless access to UE 105. Some gNBs 210 (e.g. gNB 210-2) and/or ng-eNB 214 in FIG. 2 may be configured to function as positioning-only beacons which may transmit signals (e.g., Positioning Reference Signal (PRS)) and/or may broadcast assistance data to assist positioning of UE 105 but may not receive signals from UE 105 or from other UEs. Some gNBs 210 (e.g., gNB 210-2 and/or another gNB not shown) and/or ng-eNB 214 may be configured to function as detecting-only nodes may scan for signals containing, e.g., PRS data, assistance data, or other location data. Such detecting-only nodes may not transmit signals or data to UEs but may transmit signals or data (relating to, e.g., PRS, assistance data, or other location data) to other network entities (e.g., one or more components of 5G CN 240, external client 230, or a controller) which may receive and store or use the data for positioning of at least UE 105. It is noted that while only one ng-eNB 214 is shown in FIG. 2, some embodiments may include multiple ng-eNBs 214. Base stations (e.g., gNBs 210 and/or ng-eNB 214) may communicate directly with one another via an Xn communication interface. Additionally or alternatively, base stations may communicate directly or indirectly with other components of the 5G NR positioning system 200, such as the LMF 220 and AMF 215.

5G NR positioning system 200 may also include one or more WLANs 216 which may connect to a Non-3GPP InterWorking Function (N3IWF) 250 in the 5G CN 240 (e.g., in the case of an untrusted WLAN 216). For example, the WLAN 216 may support IEEE 802.11 Wi-Fi access for UE 105 and may comprise one or more Wi-Fi APs (e.g., APs 130 of FIG. 1). Here, the N3IWF 250 may connect to other elements in the 5G CN 240 such as AMF 215. In some embodiments, WLAN 216 may support another RAT such as Bluetooth. The N3IWF 250 may provide support for secure access by UE 105 to other elements in 5G CN 240 and/or may support interworking of one or more protocols used by WLAN 216 and UE 105 to one or more protocols used by other elements of 5G CN 240 such as AMF 215. For example, N3IWF 250 may support IPSec tunnel establishment with UE 105, termination of IKEv2/IPSec protocols with UE 105, termination of N2 and N3 interfaces to 5G CN 240 for control plane and user plane, respectively, relaying of uplink (UL) and downlink (DL) control plane Non-Access Stratum (NAS) signaling between UE 105 and AMF 215 across an N1 interface. In some other embodiments, WLAN 216 may connect directly to elements in 5G CN 240 (e.g. AMF 215 as shown by the dashed line in FIG. 2) and not via N3IWF 250. For example, direct connection of WLAN 216 to 5GCN 240 may occur if WLAN 216 is a trusted WLAN for 5GCN 240 and may be enabled using a Trusted WLAN Interworking Function (TWIF) (not shown in FIG. 2) which may be an element inside WLAN 216. It is noted that while only one WLAN 216 is shown in FIG. 2, some embodiments may include multiple WLANs 216.

Access nodes may comprise any of a variety of network entities enabling communication between the UE 105 and the AMF 215. As noted, this can include gNBs 210, ng-eNB 214, WLAN 216, and/or other types of cellular base stations. However, access nodes providing the functionality described herein may additionally or alternatively include entities enabling communications to any of a variety of RATs not illustrated in FIG. 2, which may include non-cellular technologies. Thus, the term “access node,” as used in the embodiments described herein below, may include but is not necessarily limited to a gNB 210, ng-eNB 214 or WLAN 216.

In some embodiments, an access node, such as a gNB 210, ng-eNB 214, and/or WLAN 216 (alone or in combination with other components of the 5G NR positioning system 200), may be configured to, in response to receiving a request for location information from the LMF 220, obtain location measurements of uplink (UL) signals received from the UE 105) and/or obtain downlink (DL) location measurements from the UE 105 that were obtained by UE 105 for DL signals received by UE 105 from one or more access nodes. As noted, while FIG. 2 depicts access nodes (gNB 210, ng-eNB 214, and WLAN 216) configured to communicate according to 5G NR, LTE, and Wi-Fi communication protocols, respectively, access nodes configured to communicate according to other communication protocols may be used, such as, for example, a Node B using a Wideband Code Division Multiple Access (WCDMA) protocol for a Universal Mobile Telecommunications Service (UMTS) Terrestrial Radio Access Network (UTRAN), an eNB using an LTE protocol for an Evolved UTRAN (E-UTRAN), or a Bluetooth® beacon using a Bluetooth protocol for a WLAN. For example, in a 4G Evolved Packet System (EPS) providing LTE wireless access to UE 105, a RAN may comprise an E-UTRAN, which may comprise base stations comprising eNBs supporting LTE wireless access. A core network for EPS may comprise an Evolved Packet Core (EPC). An EPS may then comprise an E-UTRAN plus an EPC, where the E-UTRAN corresponds to NG-RAN 235 and the EPC corresponds to 5 GCN 240 in FIG. 2. The methods and techniques described herein for obtaining a civic location for UE 105 may be applicable to such other networks.

The gNBs 210 and ng-eNB 214 can communicate with an AMF 215, which, for positioning functionality, communicates with an LMF 220. The AMF 215 may support mobility of the UE 105, including cell change and handover of UE 105 from an access node (e.g., gNB 210, ng-eNB 214, or WLAN 216) of a first RAT to an access node of a second RAT. The AMF 215 may also participate in supporting a signaling connection to the UE 105 and possibly data and voice bearers for the UE 105. The LMF 220 may support positioning of the UE 105 using a CP location solution when UE 105 accesses the NG-RAN 235 or WLAN 216 and may support position procedures and methods, including UE assisted/UE based and/or network based procedures/methods, such as Assisted GNSS (A-GNSS), Observed Time Difference Of Arrival (OTDOA) (which may be referred to in NR as Time Difference Of Arrival (TDOA)), Frequency Difference Of Arrival (FDOA), Real Time Kinematic (RTK), Precise Point Positioning (PPP), Differential GNSS (DGNSS), Enhance Cell ID (ECID), angle of arrival (AoA), angle of departure (AoD), WLAN positioning, round trip signal propagation delay (RTT), multi-cell RTT, and/or other positioning procedures and methods. The LMF 220 may also process location service requests for the UE 105, e.g., received from the AMF 215 or from the GMLC 225. The LMF 220 may be connected to AMF 215 and/or to GMLC 225. In some embodiments, a network such as 5 GCN 240 may additionally or alternatively implement other types of location-support modules, such as an Evolved Serving Mobile Location Center (E-SMLC) or a SUPL Location Platform (SLP). It is noted that in some embodiments, at least part of the positioning functionality (including determination of a UE 105's location) may be performed at the UE 105 (e.g., by measuring downlink PRS (DL-PRS) signals transmitted by wireless nodes such as gNBs 210, ng-eNB 214 and/or WLAN 216, and/or using assistance data provided to the UE 105, e.g., by LMF 220).

The Gateway Mobile Location Center (GMLC) 225 may support a location request for the UE 105 received from an external client 230 and may forward such a location request to the AMF 215 for forwarding by the AMF 215 to the LMF 220. A location response from the LMF 220 (e.g., containing a location estimate for the UE 105) may be similarly returned to the GMLC 225 either directly or via the AMF 215, and the GMLC 225 may then return the location response (e.g., containing the location estimate) to the external client 230.

A Network Exposure Function (NEF) 245 may be included in 5GCN 240. The NEF 245 may support secure exposure of capabilities and events concerning 5GCN 240 and UE 105 to the external client 230, which may then be referred to as an Access Function (AF) and may enable secure provision of information from external client 230 to 5GCN 240. NEF 245 may be connected to AMF 215 and/or to GMLC 225 for the purposes of obtaining a location (e.g. a civic location) of UE 105 and providing the location to external client 230.

As further illustrated in FIG. 2, the LMF 220 may communicate with the gNBs 210 and/or with the ng-eNB 214 using an NR Positioning Protocol annex (NRPPa) as defined in 3GPP Technical Specification (TS) 38.455. NRPPa messages may be transferred between a gNB 210 and the LMF 220, and/or between an ng-eNB 214 and the LMF 220, via the AMF 215. As further illustrated in FIG. 2, LMF 220 and UE 105 may communicate using an LTE Positioning Protocol (LPP) as defined in 3GPP TS 37.355. Here, LPP messages may be transferred between the UE 105 and the LMF 220 via the AMF 215 and a serving gNB 210-1 or serving ng-eNB 214 for UE 105. For example, LPP messages may be transferred between the LMF 220 and the AMF 215 using messages for service-based operations (e.g., based on the Hypertext Transfer Protocol (HTTP)) and may be transferred between the AMF 215 and the UE 105 using a 5G NAS protocol. The LPP protocol may be used to support positioning of UE 105 using UE assisted and/or UE based position methods such as A-GNSS, RTK, TDOA, multi-cell RTT, AoD, and/or ECID. The NRPPa protocol may be used to support positioning of UE 105 using network based position methods such as ECID, AoA, uplink TDOA (UL-TDOA) and/or may be used by LMF 220 to obtain location related information from gNBs 210 and/or ng-eNB 214, such as parameters defining DL-PRS transmission from gNBs 210 and/or ng-eNB 214.

In the case of UE 105 access to WLAN 216, LMF 220 may use NRPPa and/or LPP to obtain a location of UE 105 in a similar manner to that just described for UE 105 access to a gNB 210 or ng-eNB 214. Thus, NRPPa messages may be transferred between a WLAN 216 and the LMF 220, via the AMF 215 and N3IWF 250 to support network-based positioning of UE 105 and/or transfer of other location information from WLAN 216 to LMF 220. Alternatively, NRPPa messages may be transferred between N3IWF 250 and the LMF 220, via the AMF 215, to support network-based positioning of UE 105 based on location related information and/or location measurements known to or accessible to N3IWF 250 and transferred from N3IWF 250 to LMF 220 using NRPPa. Similarly, LPP and/or LPP messages may be transferred between the UE 105 and the LMF 220 via the AMF 215, N3IWF 250, and serving WLAN 216 for UE 105 to support UE assisted or UE based positioning of UE 105 by LMF 220.

In a 5G NR positioning system 200, positioning methods can be categorized as being “UE assisted” or “UE based.” This may depend on where the request for determining the position of the UE 105 originated. If, for example, the request originated at the UE (e.g., from an application, or “app,” executed by the UE), the positioning method may be categorized as being UE based. If, on the other hand, the request originates from an external client 230, LMF 220, or other device or service within the 5G network, the positioning method may be categorized as being UE assisted (or “network-based”).

With a UE-assisted position method, UE 105 may obtain location measurements and send the measurements to a location server (e.g., LMF 220) for computation of a location estimate for UE 105. For RAT-dependent position methods location measurements may include one or more of a Received Signal Strength Indicator (RSSI), Round Trip signal propagation Time (RTT), Reference Signal Received Power (RSRP), Reference Signal Received Quality (RSRQ), Reference Signal Time Difference (RSTD), Time of Arrival (TOA), AoA, Receive Time-Transmission Time Difference (Rx-Tx), Differential AoA (DAOA), AoD, or Timing Advance (TA) for gNBs 210, ng-eNB 214, and/or one or more access points for WLAN 216. Additionally or alternatively, similar measurements may be made of sidelink signals transmitted by other UEs, which may serve as anchor points for positioning of the UE 105 if the positions of the other UEs are known. The location measurements may also or instead include measurements for RAT-independent positioning methods such as GNSS (e.g., GNSS pseudorange, GNSS code phase, and/or GNSS carrier phase for satellites 110), WLAN, etc.

With a UE-based position method, UE 105 may obtain location measurements (e.g., which may be the same as or similar to location measurements for a UE assisted position method) and may further compute a location of UE 105 (e.g., with the help of assistance data received from a location server such as LMF 220, an SLP, or broadcast by gNBs 210, ng-eNB 214, or WLAN 216).

With a network based position method, one or more base stations (e.g., gNBs 210 and/or ng-eNB 214), one or more APs (e.g., in WLAN 216), or N3IWF 250 may obtain location measurements (e.g., measurements of RSSI, RTT, RSRP, RSRQ, AoA, or TOA) for signals transmitted by UE 105, and/or may receive measurements obtained by UE 105 or by an AP in WLAN 216 in the case of N3IWF 250, and may send the measurements to a location server (e.g., LMF 220) for computation of a location estimate for UE 105.

Positioning of the UE 105 also may be categorized as UL, DL, or DL-UL based, depending on the types of signals used for positioning. If, for example, positioning is based solely on signals received at the UE 105 (e.g., from a base station or other UE), the positioning may be categorized as DL based. On the other hand, if positioning is based solely on signals transmitted by the UE 105 (which may be received by a base station or other UE, for example), the positioning may be categorized as UL based. Positioning that is DL-UL based includes positioning, such as RTT-based positioning, that is based on signals that are both transmitted and received by the UE 105. Sidelink (SL)-assisted positioning comprises signals communicated between the UE 105 and one or more other UEs. According to some embodiments, UL, DL, or DL-UL positioning as described herein may be capable of using SL signaling as a complement or replacement of SL, DL, or DL-UL signaling.

Depending on the type of positioning (e.g., UL, DL, or DL-UL based) the types of reference signals used can vary. For DL-based positioning, for example, these signals may comprise PRS (e.g., DL-PRS transmitted by base stations or SL-PRS transmitted by other UEs), which can be used for TDOA, AoD, and RTT measurements. Other reference signals that can be used for positioning (UL, DL, or DL-UL) may include Sounding Reference Signal (SRS), Channel State Information Reference Signal (CSI-RS), synchronization signals (e.g., synchronization signal block (SSB) Synchronizations Signal (SS)), Physical Uplink Control Channel (PUCCH), Physical Uplink Shared Channel (PUSCH), Physical Sidelink Shared Channel (PSSCH), Demodulation Reference Signal (DMRS), etc. Moreover, reference signals may be transmitted in a Tx beam and/or received in an Rx beam (e.g., using beamforming techniques), which may impact angular measurements, such as AoD and/or AoA.

As discussed herein, in some embodiments, TDOA assistance data may be provided to a UE 105 by a location server (e.g., location server 160) for a “reference cell” (which also may be called “reference resource”), and one or more “neighbor cells” or “neighboring cells” (which also may be called a “target cell” or “target resource”), relative to the reference cell. For example, the assistance data may provide the center channel frequency of each cell, various PRS configuration parameters (e.g., NPRS, TPRS, muting sequence, frequency hopping sequence, PRS ID, PRS bandwidth), a cell global ID, PRS signal characteristics associated with a directional PRS, and/or other cell related parameters applicable to TDOA or some other position method. PRS-based positioning by a UE 105 may be facilitated by indicating the serving cell for the UE 105 in the TDOA assistance data (e.g., with the reference cell indicated as being the serving cell).

In some embodiments, TDOA assistance data may also include “expected Reference Signal Time Difference (RSTD)” parameters, which provide the UE 105 with information about the RSTD values the UE 105 is expected to measure at its current location between the reference cell and each neighbor cell, together with an uncertainty of the expected RSTD parameter. The expected RSTD, together with the associated uncertainty, may define a search window for the UE 105 within which the UE 105 is expected to measure the RSTD value. TDOA assistance information may also include PRS configuration information parameters, which allow a UE 105 to determine when a PRS positioning occasion occurs on signals received from various neighbor cells relative to PRS positioning occasions for the reference cell, and to determine the PRS sequence transmitted from various cells in order to measure a signal ToA or RSTD.

Using the RSTD measurements, the known absolute or relative transmission timing of each cell, and the known position(s) of wireless node physical transmitting antennas for the reference and neighboring cells, the UE position may be calculated (e.g., by the UE 105 or by the location server 160). More particularly, the RSTD for a neighbor cell “K” relative to a reference cell “Ref,” may be given as (ToAₖ−ToA_{Ref}), where the ToA values may be measured modulo one subframe duration (1 ms) to remove the effects of measuring different subframes at different times. ToA measurements for different cells may then be converted to RSTD measurements and sent to the location server 160 by the UE 105. Using (i) the RSTD measurements, (ii) the known absolute or relative transmission timing of each cell, (iii) the known position(s) of physical transmitting antennas for the reference and neighboring cells, and/or (iv) directional PRS characteristics such as a direction of transmission, the UE 105 position may be determined.

In some embodiments, Phase Difference of Arrival (PDOA)-assisted positioning may be performed, where ranging measurements may be made based on phase difference of the propagation path between network nodes (e.g., UE 105, base station 120, 210), between the network node and an RF device (e.g., RFID tag), or between an RF reader (e.g., RFID reader) to the RF device to determine the distance to the tag. Phase errors can be small due to the very small signal bandwidth and typically limited distance. In some variants, Frequency Domain PDOA (FD-PDOA) measuring the tag phase at different frequencies may be used to determine the position of an RF device. In other variants, Time Domain PDOA (TD-PDOA) measuring of tag phases at different time points, or Spatial Domain PDOA (SD-PDOA) using a phased array antenna array to estimate AoA may be used to determine the position of an RF device.

### Zero-Power Radio Frequency (RF) Topology

RF devices such as RFID tags or transponders are devices that can interact with nearby RF or RFID readers by using low-power radio waves to receive, store, and/or transmit data. RFID tags typically contain a microchip or integrated circuit (IC), an antenna, and a material that holds the components together. RF devices may be passive, active, or semi-passive. Passive RFID tags operate without an internal power source. They are powered by the electromagnetic energy from an RF reader (e.g., RFID reader). Active RFID tags include their own transmitter and power source. Semi-passive (or battery-assisted passive) tags incorporate a power source with a passive tag configuration. RFID tags may operate in different frequency ranges, e.g., from ultra-high frequency to low frequency.

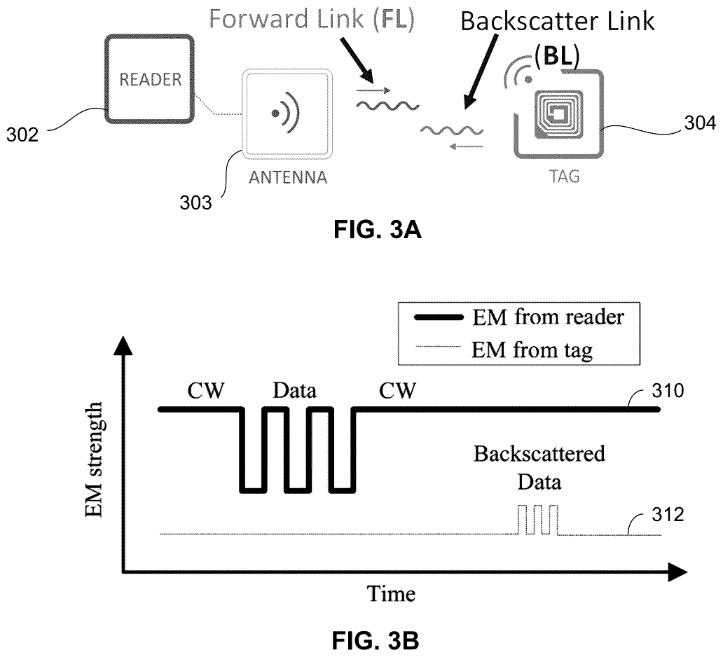

As illustrated in FIGS. 3A and 3B, RF readers and tags can form a simple communication system using backscattered RF signals. FIG. 3A is a diagram depicting an RF reader 302 (e.g., RFID reader) and an RF device 304 (e.g., RFID tag) exchanging a forward link and a backscatter link. A forward link may refer to an electromagnetic signal (also known as an interrogation signal) sent out by the RFID reader to energize RFID tag(s) 304 in the field, which may prompt a response from the tag(s) 304. A backscatter link may refer to an electromagnetic response signal sent from tag(s) 304 in the field, which may be detected by the reader 302.

FIG. 3B illustrates respective electromagnetic waves carrying information which are sent and received between a reader and a tag. A carrier wave 310 for the forward link may have been encoded to carry data. An RF reader (e.g., RFID reader 302) may modulate an RF signal (e.g., using a type of Amplitude Shift Keying) and use different encoding methods (e.g., using Pulse Interval Encoding as shown). An RF device (e.g., RFID tag 304) may respond with backscattered data corresponding to data in the carrier wave 310 for the forward link. The RFID tag 304 may send back data by switching the reflection coefficient of its antenna. Such backscattered data modulated and encoded (e.g., using methods different from the forward link, such as Phase Shift Keying modulation and FMO Baseband encoding) in a corresponding carrier wave 312 may be detected and decoded by the reader. The amplitude of the backscattered link may be lower compared to that of the forward link.

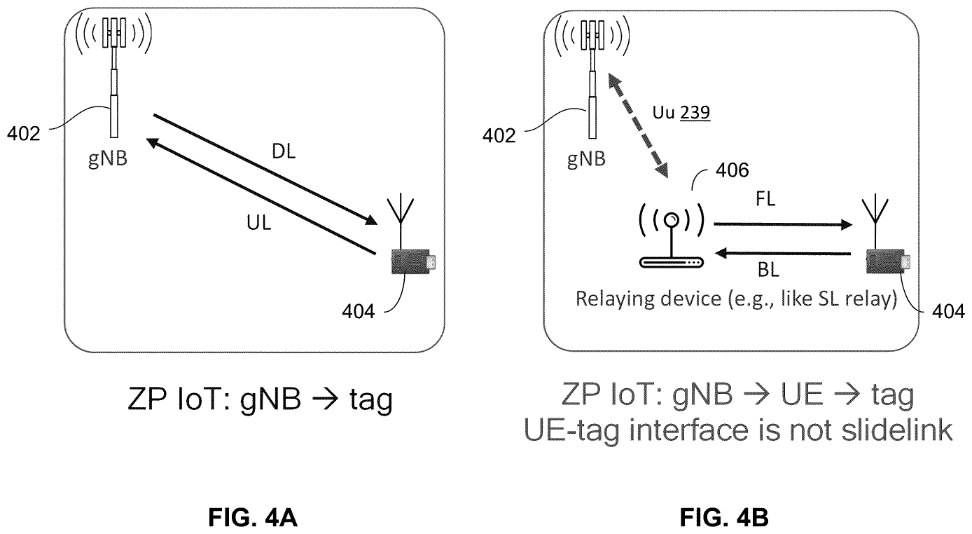

FIGS. 4A and 4B illustrate simplified diagrams of example ZP-IoT systems with and without a relay device, useful for implementing embodiments disclosed herein. FIG. 4A depicts a base station 402 (e.g., gNB) communicating with a RF device 404 (e.g., RFID tag), e.g., to perform positioning of the RF device 404. FIG. 4B illustrates an example scenario that introduces a relay device 406. In some implementations, the relay device 406 may be a UE (e.g., 105). The UE may perform positioning of the RF device 404. In some cases, the UE may locate the RF device 404 using various positioning methods (e.g., TDOA-assisted, PDOA-assisted, UE-assisted, UE-based). The UE may communicate (e.g., via sidelink communication) with other UEs, which may assist with the positioning. The UE may also communicate with the base station 402 (e.g., via Uu interface 239).

As an aside, in some implementations, the RF device may be a passive RFID tag, which does not have its own internal power source or internal carrier wave source. Such a passive tag may be powered by electromagnetic energy transmitted from an RF reader (e.g., RFID reader), and may exchange data with the RF reader using backscattered signals, as discussed with respect to FIGS. 3A and 3B. In some implementations, the RF device may be an active RFID tag having its own power source or internal carrier wave source (e.g., battery-powered RFID tag). Such an active tag may send (e.g., broadcast) its own signals, e.g., toward an RF reader or other devices such as a UE or a base station. Compared to passive tags, active tags may have a longer read range and may include a large memory configured to store data, instructions, etc. RF (e.g., RFID) systems, whether they implement a passive tag or an active tag, may include an RF reader (e.g., RFID reader or interrogator such as 302), an RF antenna (e.g., RFID antenna 303), and RF device(s) (e.g., RFID tag(s) such as 304).

Advantageously, in such topologies shown in FIGS. 4A and 4B, wireless network devices such as a base station 402 and/or a wireless-enabled UE 406 as a relay can be used for localization and positioning of RF devices, for example, as opposed to relying solely on a reader to locate an RF device. This is further advantageous because this topology can be used in situations in which the RF reader and/or the UE are moving (or fixed). In some embodiments, the RF reader may leverage the existence of nearby UEs or other network devices by requesting assistance from such devices.

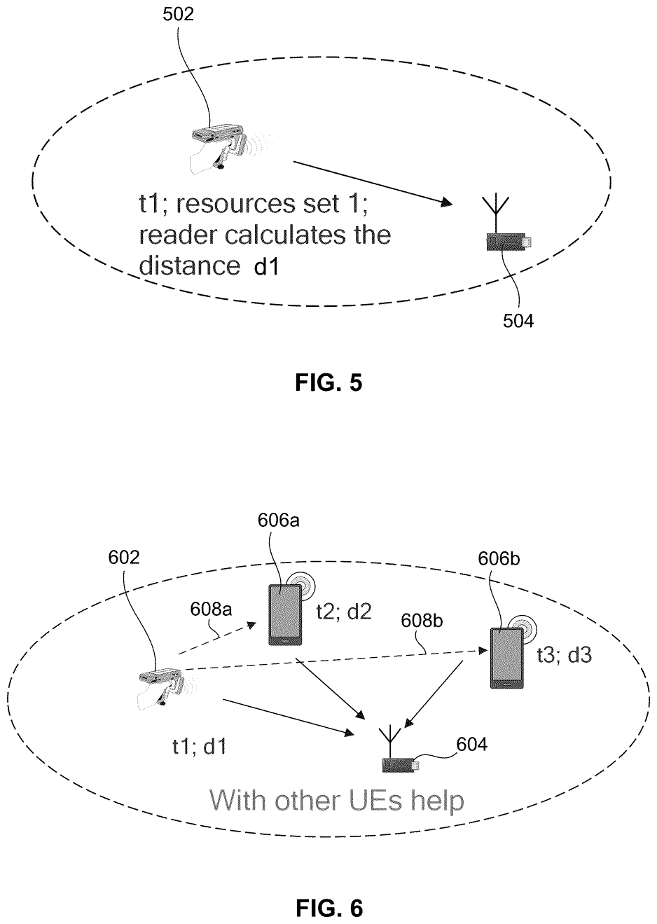

To illustrate, as shown in the example positioning scheme of FIG. 5, an RF reader (e.g., RFID reader) 502 by itself (including its communication resources) may determine a distance (d₁) to an RF device 504 (e.g., RFID tag). However, this distance information may be insufficient to locate the RF device 504. Alternatively, the RF reader 502 could take different multiple positions (e.g., from three different locations), but it may be cumbersome and slow, or the RF reader 502 may not be capable of moving quickly enough to determine distance based on a consistent location of the RF device 502, or the RF reader 502 may be fixed.

On the other hand, as shown in the example positioning scheme of FIG. 6, using one or more assistant UEs (e.g., 606a, 606b) that can communicate with an RF reader (e.g., RFID reader) 602 according to embodiments described herein can greatly improve the positioning accuracy of an RF device 604. This approach can additionally improve the distance at which the RF device 604 may be detected (e.g., by one or more assistant UEs 606a, 606b), as well as the quality (e.g., accuracy) and rate of communication and localization of the RF device 604. As will be discussed in greater detail below, in various example embodiments, an RF reader 602 may send a positioning assist request 608 to the network.

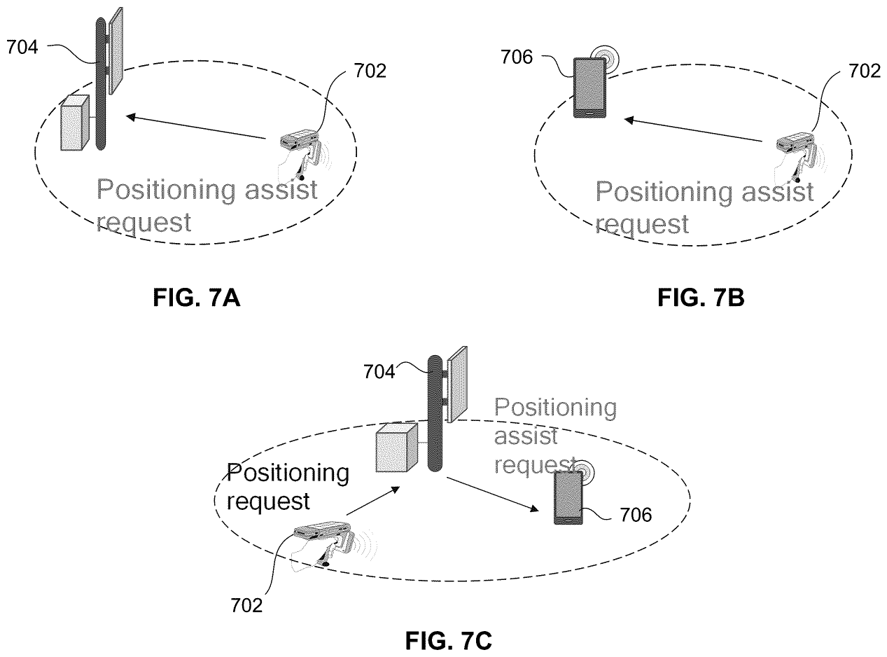

For instance, in the example embodiment depicted in FIG. 7A, an RF reader (e.g., RFID reader) 702 may send a positioning assist request to a base station 704 (e.g., gNB), which may perform positioning of an RF device. In the example embodiment depicted in FIG. 7B, the RF reader 702 may send a positioning assist request to a UE 706, which in some scenarios may perform positioning of an RF device by itself, or communicate with a base station or another assistant UE or to perform positioning of the RF device. In the example embodiment depicted in FIG. 7C, the RF reader 702 may send a positioning assist request to a base station 704, which may send its own positioning assist request (or relay the positioning assist request from the RF reader 702) to a UE 706. This scenario may be considered an extension of the example embodiment of FIG. 7A.

As alluded to previously, using the network and its devices to position an RF device can be useful in producing more accurate localization outcomes in some scenarios. For example, there may be cases in which an RF reader (e.g., RFID reader) is unable detect an RFID tag because the tag is not within range or proximate enough to determine an accurate location. This may be determined to be the case if, e.g., the RF reader queried a tag and did not receive a response after one or more queries or after a period of time (e.g., some number of seconds). Alternatively, another possibility may be that the RF reader did receive a response from a tag, but the obtained information (such as a distance (e.g., d₁) to the tag) was insufficient alone to reliably determine a position of the tag.

Accordingly, if the RF reader 702 seeks a position of an RF device (e.g., a three-dimensional (in x-y-z space) position of an RFID tag), the RF reader 702 may utilize aforementioned positioning assist requests that contain preconfigured information and assistance information with the network devices. In some embodiments, such request may be considered by the RF reader or triggered depending on one or more conditions. For example, a reader speed or Doppler velocity not exceeding a threshold, which may be specified as part of the preconfigured information, may result in such a positioning assist request being deployed. Doppler velocity may refer to the velocity or speed of a moving object (e.g., with respect to a radar or other detector). Other types of information may be specified in the preconfigured information as discussed below. Each of the above example embodiments will also be further discussed below.

### 1. RF Reader to Base Station

In some embodiments, an RF reader (e.g., RFID reader) may send a positioning assist request to a base station (e.g., gNB) to obtain the position of an RF device (e.g., RFID tag), as illustrated in FIG. 7A. The RF reader may send such positioning assist request to the base station, e.g., if the RF reader cannot detect a tag (e.g., because of distance, insufficient information for positioning, lack of response from the tag, or other reasons as mentioned above).

The RF reader may include various information in the positioning assist request to the base station. In different implementations, the information may include, a request ID, a target RF device tag ID or other related identification information, positioning method (e.g., that based on PDOA, TDOA, RSSI, TOA, or others), target precision or accuracy (e.g., a desired precision or accuracy of positioning), past and/or current location of the RF reader (which may enable the base station to locate nearby UEs if necessary), a threshold for a speed or velocity of the RF reader, Doppler velocity associated with the RF reader, known previous location(s) of the RF device (which may enable the base station to have information on possible location(s) of the RF device and save signaling overhead), a trust list that includes information on authorized UEs that can join and perform a positioning procedure (e.g., UEs associated with one other such as those associated with family members), detectability of a tag and/or detection capability of the RF device (e.g., whether or not the RF reader can detect the tag, e.g., based on distance or lack of response from the tag), information relating to expected time of the positioning behavior (e.g., start, end, window, duration), or a combination thereof.

In some implementations, the base station may use the positioning assist request to schedule UEs for positioning. For example, based on information on the detectability of the tag and/or the detection capability of the RF device in the positioning assist request, the base station may determine that the RF reader can detect the tag. IN such case, then base station may schedule nearby UEs to the RF reader to assist with positioning. If the base station determines that the RF reader cannot detect this tag, then base station may recruit other UEs that are not necessarily proximate the RF reader.

In some implementations, in order to save signaling overhead, when sending information about the RF with the positioning assist request to the base station, e.g., RF reader location information, such RF reader location info may include a zone ID in which the RF reader was in at the time of sending or at the time of configuring the positioning assist request. In V2X communications, zone ID may refer to an identifier that indicates which of the divided regions of a given area the transmitting device is located in. In some variants, the RF reader location information may include one or more zone IDs in which the RF has previously been in within a trailing period of time (e.g., past 30 minutes). In some implementations, the zone ID or other cell information may be used to select UEs that can perform the positioning procedure.

### 2. RF Reader to Nearby UE

In some embodiments, an RF reader may send a positioning assist request to one or more nearby UEs to obtain the position of an RF device, as illustrated in FIG. 7B. The RF reader may send such positioning assist request to the UE(s), e.g., if the RF reader cannot detect a tag (e.g., because of distance, insufficient information for positioning, lack of response from the tag, or other reasons as mentioned above). In various implementations, the positioning assist request may be sent via sidelink communication (e.g., if direct from RF reader to UE), Uu interface (e.g., if relayed by a base station), or any other interface that is configured to deliver data between devices.

The RF reader may include various information in the positioning assist request to the nearby UE(s). In different implementations, the types of information my include those described above with respect to the positioning assist request sent to the base station. Further information may be included as described below.

In some implementations, the information in the positioning assist request to the nearby UE(s) may further include a threshold or a target for the speed and/or a threshold or a target for the Doppler velocity or demand of the nearby assistant UE. Providing at least the threshold or target in the positioning assist request may allow the assistant UE to determine whether to participate in positioning. If the UE is moving too fast (e.g., above a speed threshold), the UE may not be involved, as the accuracy of positioning may be insufficient. In some situations, the speed and/or the Doppler velocity of UE(s) may be known by the RF reader, in which case, the positioning assist request need not be sent to UE(s) that exceed the threshold, since it is not desirable to use such UE(s) for assistance with positioning of the RF device.

In some implementations, the information in the positioning assist request to the nearby UE(s) may further include a threshold or a target for the distance or distance range of the UE. If the UE is very near to the RF reader (e.g., within a first threshold distance from the RF reader), the UE may not be needed or involved in positioning of the RF device, as such a UE may have similar detection difficulties as the RF reader from a similar location. If the UE is too far away (e.g., beyond a second threshold distance from the RF reader), the UE may also be not called up on for positioning, as detectability of the RF device and positioning may become an issue from a large distance.

In some implementations, the information in the positioning assist request to the nearby UE(s) may further include communication resources (e.g., which may be provided by the UE or the base station) for the UE to provide information on whether or not the UE can or will assist in positioning of the RF device, which can include feedback relating to determination to provide positioning assistance to the RF reader.

In some cases, the RF reader may decide which of multiple assistant UEs should help, which may be determined according to information, e.g., speed of the UEs (assuming the speeds of at least some of the multiple UEs are known); distance, direction, or location of the UEs; a power state of the UEs (e.g., if a UE has a low enough power, it may not be used for positioning); or a combination thereof. Such information may be provided as feedback from the UEs to the RF reader.

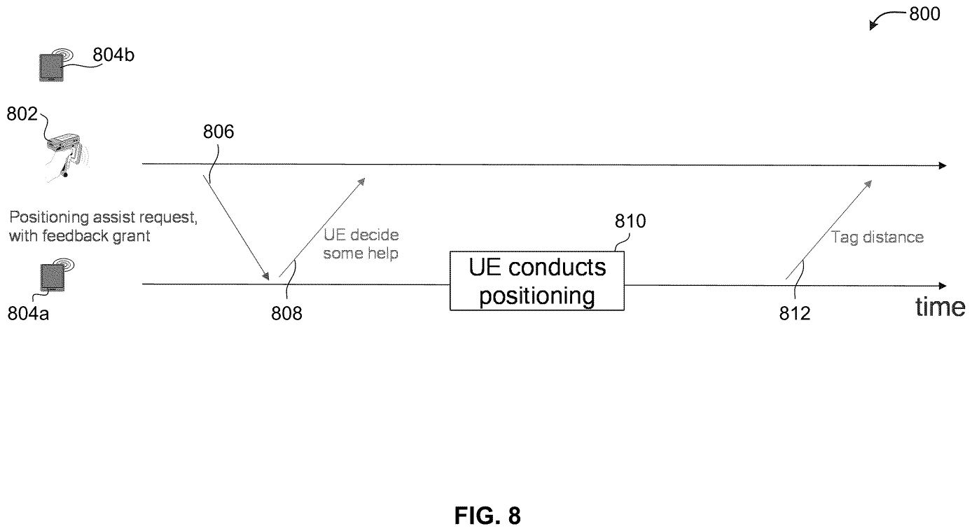

FIG. 8 illustrates a signaling flow diagram 800 between an RF reader 802 and a nearby assistant UE 804a, according to some embodiments. Signals and/or messages may be exchanged between the RF reader 802 and one or more assistant UEs (including, e.g., UEs 804a, 804b), although signaling is shown with one UE 804a for illustrative purposes.

At 806, the RF reader 802 may send a positioning assist request to a nearby assistant UE 804, as described above (e.g., if the RF reader 802 cannot detect a tag). The nearby assistant UE 804a may receive the positioning assist request from the RF reader 802.

In some embodiments, based on the positioning assist request received by the UE 804a, the UE 804a may determine whether or not to provide positioning assistance to the RF reader.

If the UE 804a decides to provide assistance, at 808, the UE 804a may send feedback information to the RF device 802, indicating that the UE 804a will assist and participate in positioning of the RF device.

At 810, the UE 804a may conduct positioning to determine location information of the RF device, e.g., a distance to the RF device and/or a position or an estimated position of the RF device. In some cases, positioning may be initiated by sending a positioning request to the base station, looking for communication resources. In some cases, positioning may be initiated by sense suitable communication resources.

In different implementations, positioning methods may be based on PDOA, TDOA, RSSI, TOA, etc. For example, in PDOA-assisted positioning, ranging measurements may be made based on phase difference of the propagation path between the one or more UEs and the RF device to determine the distance to the RF device. FD-PDOA may be used in some implementations. As another example, TDOA assistance data may be provided to the one or more UEs by a location server to, e.g., determine ToAs and measure RSTD. As another example, positioning signals may be sent toward the RF device (or previously known or estimated locations), and measurements (such as RSSI, RTT, RSRP, RSRQ, TOA) may be obtained by the one or more UEs and sent to the location server to determine a location estimation for the RF device.

At 812, the UE 804a may send the location information of the RF device to the RF reader 802. Examples of the location information may include distance, position, and/or estimated position of the RF device. In some implementations, the UE 804a may also send further related information in addition to the distance, position, and/or estimated position of the RF device, such as whether the RF device was detected, the position of the UE 804a (e.g., zone ID, world coordinates, or other location information).

In some cases, the location information sent to the RF device may enable the RF reader to locate, detect, or otherwise obtain a position or estimated position the RF device. The RF reader 802 may then, e.g., change location to interact with the RF device.

### 3. Base Station to UE

In some embodiments, an RF reader may send a first positioning assist request to a base station to obtain the position of an RF device, and the base station may send a second positioning assist request to one or more assistant UEs, as illustrated in FIG. 7C. In some cases, the first and second positioning assist requests may be the same; i.e., the base station may forward the initial positioning assist request received to the assistant UE(s). The RF reader may send such positioning assist request to the base station, e.g., if the RF reader cannot detect a tag (e.g., because of distance, insufficient information for positioning, lack of response from the tag, or other reasons as mentioned above).

The base station may include various information in the positioning assist request to the assistant UE(s). In different implementations, the types of information my include those described above with respect to the positioning assist request sent to the base station and/or those described above with respect to the positioning assist request sent to the nearby UE(s).

In some implementations, the information in the positioning assist request to the base station or to the UE may include a threshold or a target for the speed and/or Doppler velocity or demand of the UE. If the UE is moving too fast (e.g., above the speed threshold), the UE may not be involved, as the accuracy of positioning may be insufficient. In some cases, the RF reader may already be aware of the speed or the Doppler velocity of the UE, in which case the positioning assist request need not be sent to the base station.

In some implementations, the information in the positioning assist request to the base station or to the UE may include uplink (UL) resources for the UE to provide feedback information as to whether the UE can assist or not.

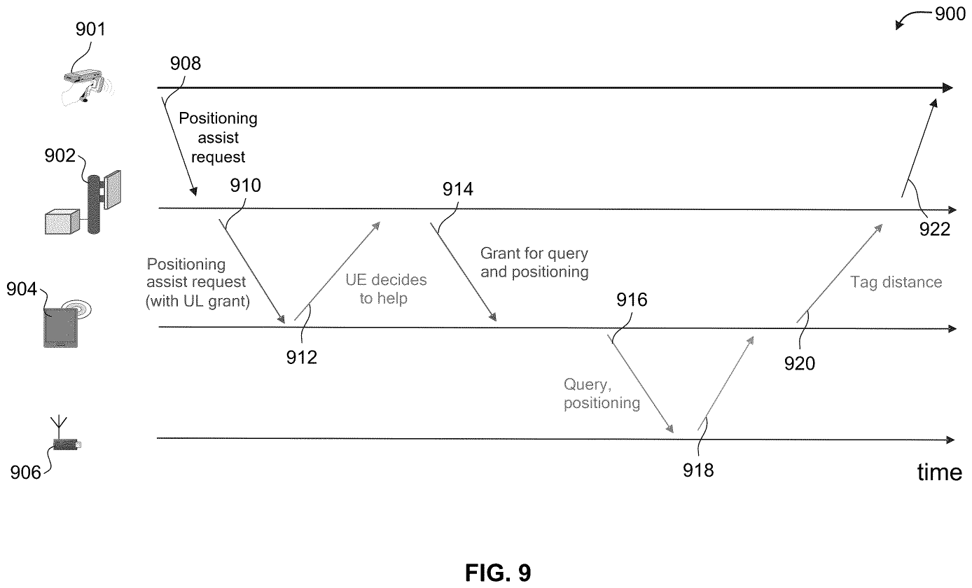

FIG. 9 illustrates a signaling flow diagram 900 among an RF reader 901, a base station 902, and an assistant UE 904, according to some embodiments. Signals and/or messages may be exchanged among the RF reader 901, base station 902, one or more assistant UEs (including, e.g., UE 904), and an RF device 906 (e.g., RFID tag) although signaling is shown with one UE 904 for illustrative purposes.

At 908, the RF reader 901 may send a positioning assist request to a base station 902 of a network, as described above (e.g., if the RF reader 901 cannot detect a tag).

At 910, the base station 902 may send a positioning assist request to an assistant UE 904 within the network and communication range of the base station 902. In some implementations, the positioning assist request sent to the base station 902 may be a first positioning assist request, and the positioning assist request sent to the assistant UE 904 may be a second positioning assist request (including UL communication resources to receive feedback information from the UE 904) different from the first positioning assist request, each configured and sent by the RF reader 901 and the base station 902. In some implementations, the same positioning assist request sent to the base station 902 may be relayed to the assistant UE 904.

In some embodiments, based on the positioning assist request received by the UE 904, the UE 904 may determine whether or not to provide positioning assistance to the RF reader 901.

If the UE 904 decides to provide assistance, at 912, the UE 904 may send feedback information to the base station 902 (e.g., based on UL resources provided in the positioning assist request received by the UE 904), indicating that the UE 904 will assist and participate in positioning of the RF device 906.

At 914, the base station 902 may grant resources to the UE 904 for querying the RF device 906 and conducting positioning with the RF device 906. In some implementations, the grant may be associated with the (second) positioning assist request via an identifier (e.g., a request ID), or via a timing relationship, or both.

At 916, the UE 904 may conduct positioning of the RF device 906, e.g., by sending a signal toward the RF device 906. At 918, signals may be received from the RF device 906. In some cases, a received signal may be a backscattered signal if the RF device 906 is a passive tag. In some cases, received signal may be an active signal transmission if the RF device 906 is an active tag.

In some embodiments, the positioning by the UE 904 may involve signals and/or messages at 916 and 918. The positioning method may be based on PDOA, TDOA, RSSI, TOA, etc., and may involve multiple UEs and/or the base station to effectuate the positioning, as discussed above.

In some embodiments, based on the conducted positioning, the UE 904 may determine location information of the RF device, e.g., a distance to the RF device and/or a position or an estimated position of the RF device.

At 920, the UE 904 may send the location information of the RF device to the base station 902. Examples of the location information may include distance, position, and/or estimated position of the RF device. In some implementations, the UE may also send further related information in addition to the distance, position, and/or estimated position of the RF device 906, such as whether the RF device was detected, the position of the UE 904 (e.g., zone ID, world coordinates, or other location information).

At 922, the base station 902 may send the location information to the RF reader 901. In some cases, the location information may enable the RF reader 901 to locate, detect, or otherwise obtain a position or estimated position the RF device. The RF reader 901 may then, e.g., change location to interact with the RF device.

### Methods

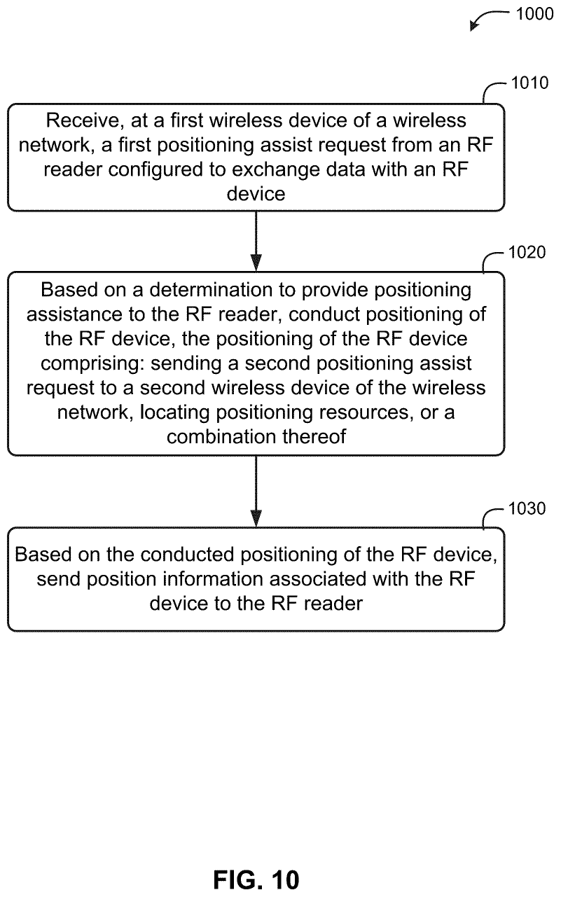

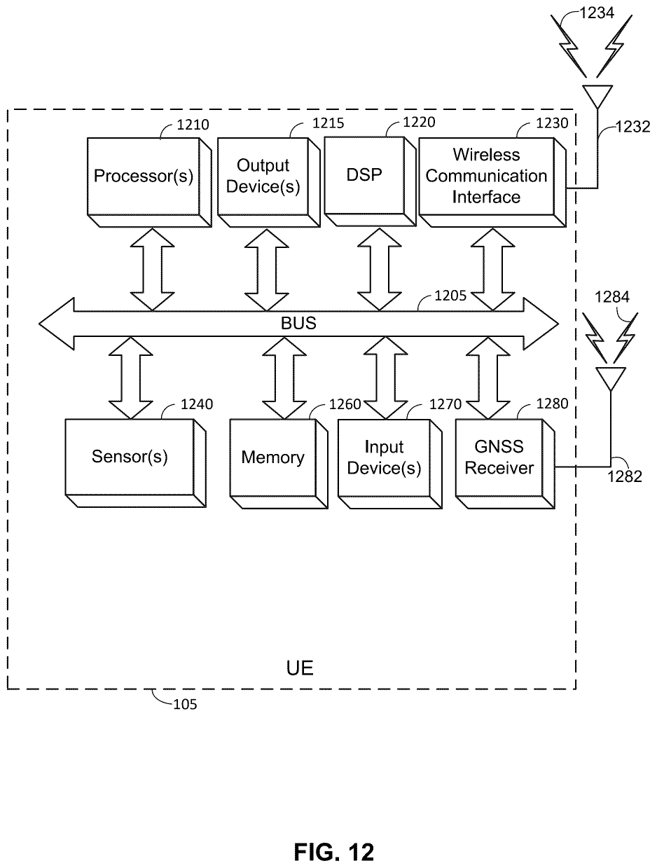

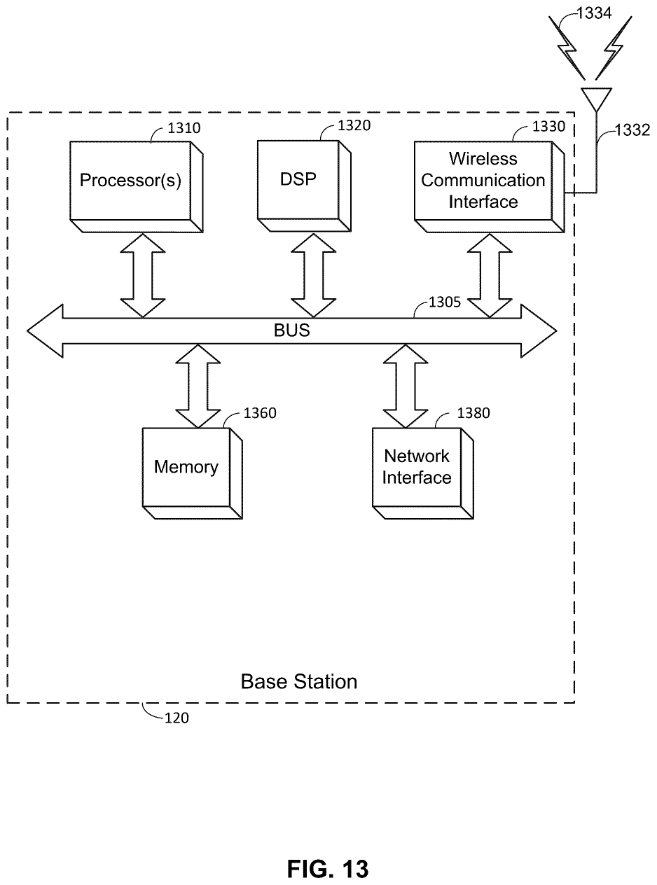

FIG. 10 is a flow diagram of a method 1000 of determining a position of a radio frequency (RF) device within a wireless network, according to some embodiments. Structure for performing the functionality illustrated in one or more of the blocks shown in FIG. 10 may be performed by hardware and/or software components of a computerized apparatus or system, e.g., a UE (e.g., 105) or base station (e.g., 120, 210). Components of such computerized apparatus or system may include, for example, a controller apparatus, a computerized system, or a computer-readable apparatus including a storage medium storing computer-readable and/or computer-executable instructions that are configured to, when executed by a processor apparatus, cause the processor apparatus or a computerized apparatus to perform the operations. Example components of a UE and a base station are illustrated in FIGS. 12 and 13, which are described in more detail below.

It should also be noted that the operations of the method 1000 may be performed in any suitable order, not necessarily the order depicted in FIG. 10. Further, the method 1000 may include additional or fewer operations than those depicted in FIG. 10.

At block 1010, the functionality may include receiving, at a first wireless device of the wireless network, a first positioning assist request from an RF reader configured to exchange data with the RF device. In some embodiments, the RF reader may be, e.g., an RFID reader, and the RF device may be, e.g., an RFID tag. In some implementations, the RF device may be a passive RF device without an internal power source, and the RF reader may be further configured to exchange data with the RF device through RF signals backscattered from the RF reader. In some implementations, the RF device may be an active RF device with an internal power source, and the active RF device may be configured to send signals to the RF reader, and the RF reader may be configured to receive such signals sent by the RF device to the RF reader. More specifically, in some cases, the RF device tag may be a passive RF tag or transponder, or an active RF tag or transponder.

In some embodiments, the first wireless device of the wireless network may be a first UE or a first base station. That is, in some cases, the first wireless device may be an assistant UE configured to conduct positioning of the RF device. UEs 105, 406, 606, 706, 804a, 904 may be examples of such first UE. In some cases, the first wireless device may be a first base station (e.g., gNB). Base station (e.g., gNB) 402, 704, 902 may be examples of such first base station.

In some embodiments, the received first positioning assist request may be an example of the positioning assist request sent from an RF reader to a base station or to an assistant UE (as illustrated with respect to FIG. 7A or 7B) and include information relating to a location of the RF reader. In some implementations, the information relating to the location of the RF reader may include a zone identifier (zone ID) of the RF reader at a time when the positioning assist request was sent by the reader.

In some embodiments, the received first positioning assist request may include: a list of wireless devices authorized to conduct the positioning of the RF device, the list of wireless devices including the first wireless device of the wireless network; communication resources for sending, to the RF reader, feedback information relating to determination to provide positioning assistance to the RF reader; identification information of the RF device; a method of the conducted positioning of the RF device; a threshold for a speed of the first wireless device of the wireless network; a speed of the RF reader; information relating to expected time of the positioning; or a combination thereof. Depending on the implementation, the method of the conducted positioning of the RF device may be based on PDOA, TDOA, RSSI, TOA, or other suitable UE-or network-assisted methods.

Means for performing functionality at block 1010 may comprise processor(s) 1210 or processor(s) 1310, wireless communication interface 1230 or wireless communication interface 1330, wireless communication antenna(s) 1232 or wireless communication antenna(s) 1332, and/or other components of a UE or base station, as illustrated in FIGS. 12 and 13.

At block 1020, the functionality may include, based on a determination to provide positioning assistance to the RF reader, conducting positioning of the RF device. In some embodiments, the positioning of the RF device may include: sending a second positioning assist request to a second wireless device of the wireless network, locating positioning resources, or a combination thereof.

In some embodiments, the second wireless device of the wireless network may be a second UE configured for data communication with the first base station (as mentioned with respect to block 1010) or a second base station configured for data communication with the first UE (as mentioned with respect to block 1010).

In some implementations, the determination to provide positioning assistance to the RF reader may be based at least on the information relating to a speed of the first wireless device of the wireless network, a location of the first wireless device, the location of the RF reader, a previously known location of the RF device, or a combination thereof. Such information may further include a threshold for the speed or Doppler velocity of the first wireless device and/or a distance threshold (e.g., between RF reader and first wireless device). In some cases, these types of information may be dynamically configured to the first wireless device of the wireless network (e.g., provided in the first positioning assist request), or in some cases, the information can be preconfigured in the first wireless device of the wireless network.

In some embodiments, the second positioning assist request may be an example of the positioning assist request sent from a base station to an assistant UE (as illustrated with respect to FIG. 7C) and may include: communication resources for sending, to the second wireless device, feedback relating to determination to provide positioning assistance to the RF reader; identification information of the RF device; a method of the conducted positioning of the RF device; a threshold for a speed of the first wireless device of the wireless network; a speed of the RF reader; information relating to expected time of the positioning; or a combination thereof. In some cases, the first and second positioning assist request may be the same and relayed between network devices, e.g., received at a base station from the RF reader, and sent to an assistant UE from the base station.

Means for performing functionality at block 1020 may comprise processor(s) 1210 or processor(s) 1310, wireless communication interface 1230 or wireless communication interface 1330, wireless communication antenna(s) 1232 or wireless communication antenna(s) 1332, and/or other components of a UE or base station, as illustrated in FIGS. 12 and 13.

At block 1030, the functionality may include, based on the conducted positioning of the RF device, sending position information associated with the RF device to the RF reader. In some implementations, the position information associated with the RF device may include a distance of the RF device to the RF reader, a position of the RF device, information relating to a location of an assistance wireless device, or a combination thereof.

In some cases, the position information may enable the RF reader to locate, detect, or otherwise obtain a position or estimated position the RF device. The RF reader may then, e.g., change location to interact with the RF device by exchanging signals that unable to be performed prior to the positioning assistance by the first wireless device of the wireless network.

Means for performing functionality at block 1030 may comprise processor(s) 1210 or processor(s) 1310, wireless communication interface 1230 or wireless communication interface 1330, wireless communication antenna(s) 1232 or wireless communication antenna(s) 1332, and/or other components of a UE or base station, as illustrated in FIGS. 12 and 13.

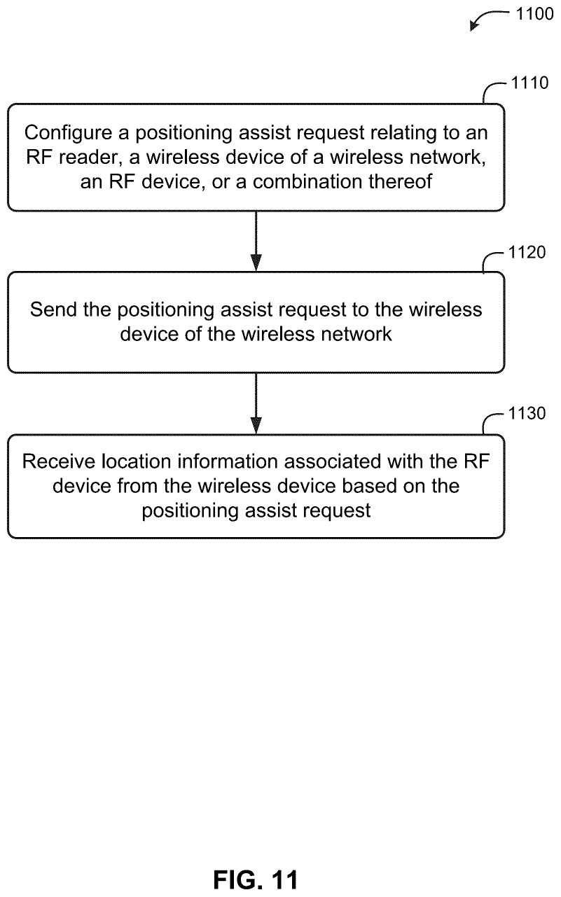

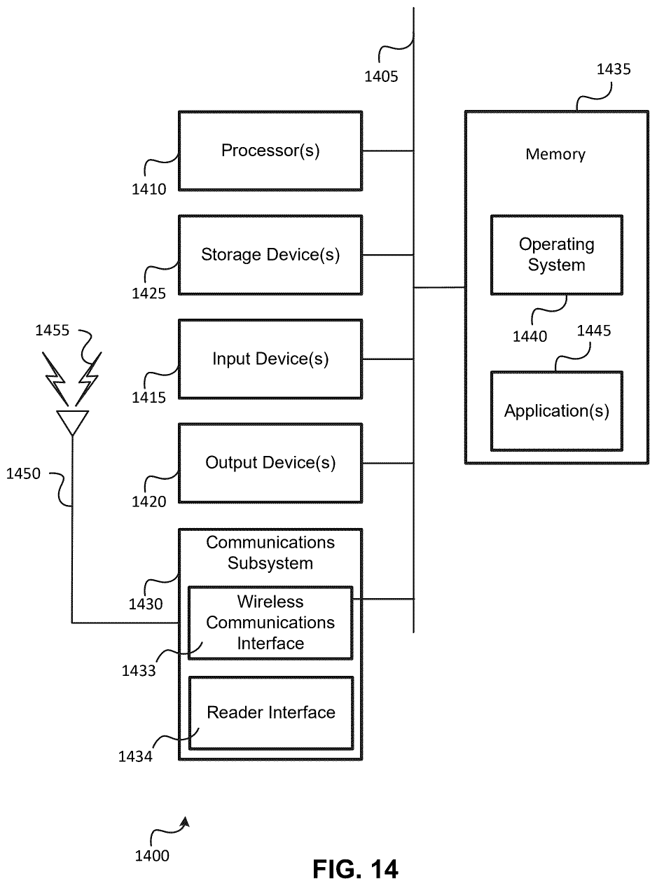

FIG. 1111 is a flow diagram of a method 1100 of determining a position of a radio frequency (RF) device within a wireless network, according to some embodiments. Structure for performing the functionality illustrated in one or more of the blocks shown in FIG. 11 may be performed by hardware and/or software components of a computerized apparatus or system, e.g., an RF reader (such as an RFID reader). Components of such computerized apparatus or system may include, for example, a controller apparatus, a computerized system, or a computer-readable apparatus including a storage medium storing computer-readable and/or computer-executable instructions that are configured to, when executed by a processor apparatus, cause the processor apparatus or a computerized apparatus to perform the operations. Example components of the RF reader are illustrated in FIG. 14, which is described in more detail below.

It should also be noted that the operations of the method 1100 may be performed in any suitable order, not necessarily the order depicted in FIG. 11. Further, the method 1100 may include additional or fewer operations than those depicted in FIG. 11.

At block 1110, the functionality may include configuring a positioning assist request relating to the RF reader, a wireless device of the wireless network, the RF device, or a combination thereof. In some embodiments, the RF reader may be, e.g., an RFID reader, and the RF device may be, e.g., an RFID tag. In some implementations, the RF device may be a passive RF device. In some implementations, the RF device may be an active RF device.

In some embodiments, the wireless device of the wireless network may be a UE or a base station. UEs 105, 406, 606, 706, 804a, 904 may be examples of a UE. Base station (e.g., gNB) 402, 704, 902 may be examples of a base station.

Means for performing functionality at block 1110 may comprise processor(s) 1410 and/or other components of a computer system, as illustrated in FIG. 14.

At block 1120, the functionality may include sending the positioning assist request to the wireless device of the wireless network. In some embodiments, the positioning assist request may include various information such as information relating to a location of the RF reader (which may include a zone ID of the RF reader at a time when the positioning assist request was sent by the reader), a list of wireless devices authorized to conduct the positioning of the RF device, the list of wireless devices including the wireless device of the wireless network; communication resources for sending, to the RF reader, feedback information relating to determination to provide positioning assistance to the RF reader; identification information of the RF device; a method of the conducted positioning of the RF device; a threshold for a speed of the wireless device of the wireless network; a speed of the RF reader; information relating to expected time of the positioning; or a combination thereof. Other types of information as described herein relating to positioning assist requests (e.g., the aforementioned first positioning assist request or second positioning assist request) may also be included.

Means for performing functionality at block 1120 may comprise processor(s) 1410, wireless communication interface 1433, wireless antenna(s) 1450, and/or other components of a computer system, as illustrated in FIG. 14.

At block 1130, the functionality may include receiving location information associated with the RF device from the wireless device based on the positioning assist request. In some embodiments, the location information (sent by the wireless device) associated with the RF device may include distance, position, and/or estimated position of the RF device. In some implementations, the wireless device may also send further information, such as whether the RF device was detected, the position of the wireless device (e.g., zone ID, world coordinates, or other location information).

Means for performing functionality at block 1130 may comprise processor(s) 1410, wireless communication interface 1433, wireless antenna(s) 1450, and/or other components of a computer system, as illustrated in FIG. 14.

### Apparatus

FIG. 12 is a block diagram of an embodiment of a UE 105, which can be utilized as described herein above (e.g., in association with FIGS. 4B, 6, 7B, 7C and 8-10). For example, the UE 105 can perform one or more of the functions of the method shown in FIG. 10. It should be noted that FIG. 12 is meant only to provide a generalized illustration of various components, any or all of which may be utilized as appropriate. It can be noted that, in some instances, components illustrated by FIG. 12 can be localized to a single physical device and/or distributed among various networked devices, which may be disposed at different physical locations. Furthermore, as previously noted, the functionality of the UE discussed in the previously described embodiments may be executed by one or more of the hardware and/or software components illustrated in FIG. 12.

The UE 105 is shown comprising hardware elements that can be electrically coupled via a bus 1205 (or may otherwise be in communication, as appropriate). The hardware elements may include a processor(s) 1210 which can include without limitation one or more general-purpose processors (e.g., an application processor), one or more special-purpose processors (such as digital signal processor (DSP) chips, graphics acceleration processors, application specific integrated circuits (ASICs), and/or the like), and/or other processing structures or means. Processor(s) 1210 may comprise one or more processing units, which may be housed in a single integrated circuit (IC) or multiple ICs. As shown in FIG. 12, some embodiments may have a separate DSP 1220, depending on desired functionality. Location determination and/or other determinations based on wireless communication may be provided in the processor(s) 1210 and/or wireless communication interface 1230 (discussed below). The UE 105 also can include one or more input devices 1270, which can include without limitation one or more keyboards, touch screens, touch pads, microphones, buttons, dials, switches, and/or the like; and one or more output devices 1215, which can include without limitation one or more displays (e.g., touch screens), light emitting diodes (LEDs), speakers, and/or the like.

The UE 105 may also include a wireless communication interface 1230, which may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMAX device, a WAN device, and/or various cellular devices, etc.), and/or the like, which may enable the UE 105 to communicate with other devices as described in the embodiments above. The wireless communication interface 1230 may permit data and signaling to be communicated (e.g., transmitted and received) with TRPs of a network, for example, via eNBs, gNBs, ng-eNBs, access points, various base stations and/or other access node types, and/or other network components, computer systems, and/or any other electronic devices communicatively coupled with TRPs, as described herein. The communication can be carried out via one or more wireless communication antenna(s) 1232 that send and/or receive wireless signals 1234. According to some embodiments, the wireless communication antenna(s) 1232 may comprise a plurality of discrete antennas, antenna arrays, or any combination thereof. The antenna(s) 1232 may be capable of transmitting and receiving wireless signals using beams (e.g., Tx beams and Rx beams). Beam formation may be performed using digital and/or analog beam formation techniques, with respective digital and/or analog circuitry. The wireless communication interface 1230 may include such circuitry.

Depending on desired functionality, the wireless communication interface 1230 may comprise a separate receiver and transmitter, or any combination of transceivers, transmitters, and/or receivers to communicate with base stations (e.g., ng-eNBs and gNBs) and other terrestrial transceivers, such as wireless devices and access points. The UE 105 may communicate with different data networks that may comprise various network types. For example, a WWAN may be a CDMA network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a WiMAX (IEEE 802.16) network, and so on. A CDMA network may implement one or more RATs such as CDMA2000®, WCDMA, and so on. CDMA2000® includes IS-95, IS-2000 and/or IS-856 standards. A TDMA network may implement GSM, Digital Advanced Mobile Phone System (D-AMPS), or some other RAT. An OFDMA network may employ LTE, LTE Advanced, 5G NR, and so on. 5G NR, LTE, LTE Advanced, GSM, and WCDMA are described in documents from 3GPP. CDMA 2000® is described in documents from a consortium named “3rd Generation Partnership Project 2” (3GPP2). 3GPP and 3GPP2 documents are publicly available. A wireless local area network (WLAN) may also be an IEEE 802.11x network, and a wireless personal area network (WPAN) may be a Bluetooth network, an IEEE 802.15x, or some other type of network. The techniques described herein may also be used for any combination of WWAN, WLAN and/or WPAN.

The UE 105 can further include sensor(s) 1240. Sensor(s) 1240 may comprise, without limitation, one or more inertial sensors and/or other sensors (e.g., accelerometer(s), gyroscope(s), camera(s), magnetometer(s), altimeter(s), microphone(s), proximity sensor(s), light sensor(s), barometer(s), and the like), some of which may be used to obtain position-related measurements and/or other information.

Embodiments of the UE 105 may also include a Global Navigation Satellite System (GNSS) receiver 1280 capable of receiving signals 1284 from one or more GNSS satellites using an antenna 1282 (which could be the same as antenna 1232). Positioning based on GNSS signal measurement can be utilized to complement and/or incorporate the techniques described herein. The GNSS receiver 1280 can extract a position of the UE 105, using conventional techniques, from GNSS satellites of a GNSS system, such as Global Positioning System (GPS), Galileo, GLONASS, Quasi-Zenith Satellite System (QZSS) over Japan, IRNSS over India, BeiDou Navigation Satellite System (BDS) over China, and/or the like. Moreover, the GNSS receiver 1280 can be used with various augmentation systems (e.g., a Satellite Based Augmentation System (SBAS)) that may be associated with or otherwise enabled for use with one or more global and/or regional navigation satellite systems, such as, e.g., Wide Area Augmentation System (WAAS), European Geostationary Navigation Overlay Service (EGNOS), Multi-functional Satellite Augmentation System (MSAS), and Geo Augmented Navigation system (GAGAN), and/or the like.

It can be noted that, although GNSS receiver 1280 is illustrated in FIG. 12 as a distinct component, embodiments are not so limited. As used herein, the term “GNSS receiver” may comprise hardware and/or software components configured to obtain GNSS measurements (measurements from GNSS satellites). In some embodiments, therefore, the GNSS receiver may comprise a measurement engine executed (as software) by one or more processors, such as processor(s) 1210, DSP 1220, and/or a processor within the wireless communication interface 1230 (e.g., in a modem). A GNSS receiver may optionally also include a positioning engine, which can use GNSS measurements from the measurement engine to determine a position of the GNSS receiver using an Extended Kalman Filter (EKF), Weighted Least Squares (WLS), particle filter, or the like. The positioning engine may also be executed by one or more processors, such as processor(s) 1210 or DSP 1220.

The UE 105 may further include and/or be in communication with a memory 1260. The memory 1260 can include, without limitation, local and/or network accessible storage, a disk drive, a drive array, an optical storage device, a solid-state storage device, such as a random access memory (RAM), and/or a read-only memory (ROM), which can be programmable, flash-updateable, and/or the like. Such storage devices may be configured to implement any appropriate data stores, including without limitation, various file systems, database structures, and/or the like.

The memory 1260 of the UE 105 also can comprise software elements (not shown in FIG. 12), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions in memory 1260 that are executable by the UE 105 (and/or processor(s) 1210 or DSP 1220 within UE 105). In some embodiments, then, such code and/or instructions can be used to configure and/or adapt a general-purpose computer (or other device) to perform one or more operations in accordance with the described methods.

FIG. 13 is a block diagram of an embodiment of a base station 120, which can be utilized as described herein above (e.g., in association with FIGS. 4A, 4B, 7A, 7C, 9 and 10). It should be noted that FIG. 13 is meant only to provide a generalized illustration of various components, any or all of which may be utilized as appropriate. In some embodiments, the base station 120 may correspond to a gNB, an ng-eNB, and/or (more generally) a TRP.

The base station 120 is shown comprising hardware elements that can be electrically coupled via a bus 1305 (or may otherwise be in communication, as appropriate). The hardware elements may include a processor(s) 1310 which can include without limitation one or more general-purpose processors, one or more special-purpose processors (such as DSP chips, graphics acceleration processors, ASICs, and/or the like), and/or other processing structure or means. As shown in FIG. 13, some embodiments may have a separate DSP 1320, depending on desired functionality. Location determination and/or other determinations based on wireless communication may be provided in the processor(s) 1310 and/or wireless communication interface 1330 (discussed below), according to some embodiments. Depending on desired functionality, the wireless communication interface 1330 may comprise a separate receiver and transmitter, or any combination of transceivers, transmitters, and/or receivers to communicate with wireless devices. The base station 120 also can include one or more input devices, which can include without limitation a keyboard, display, mouse, microphone, button(s), dial(s), switch(es), and/or the like; and one or more output devices, which can include without limitation a display, light emitting diode (LED), speakers, and/or the like.

The base station 120 might also include a wireless communication interface 1330, which may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMAX device, cellular communication facilities, etc.), and/or the like, which may enable the base station 120 to communicate as described herein. The wireless communication interface 1330 may permit data and signaling to be communicated (e.g., transmitted and received) to UEs, other base stations/TRPs (e.g., eNBs, gNBs, and ng-eNBs), and/or other network components, computer systems, and/or any other electronic devices described herein. The communication can be carried out via one or more wireless communication antenna(s) 1332 that send and/or receive wireless signals 1334.

The base station 120 may also include a network interface 1380, which can include support of wireline communication technologies. The network interface 1380 may include a modem, network card, chipset, and/or the like. The network interface 1380 may include one or more input and/or output communication interfaces to permit data to be exchanged with a network, communication network servers, computer systems, and/or any other electronic devices described herein.

In many embodiments, the base station 120 may further comprise a memory 1360. The memory 1360 can include, without limitation, local and/or network accessible storage, a disk drive, a drive array, an optical storage device, a solid-state storage device, such as a RAM, and/or a ROM, which can be programmable, flash-updateable, and/or the like. Such storage devices may be configured to implement any appropriate data stores, including without limitation, various file systems, database structures, and/or the like.

The memory 1360 of the base station 120 also may comprise software elements (not shown in FIG. 13), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions in memory 1360 that are executable by the base station 120 (and/or processor(s) 1310 or DSP 1320 within base station 120). In some embodiments, then, such code and/or instructions can be used to configure and/or adapt a general-purpose computer (or other device) to perform one or more operations in accordance with the described methods.

FIG. 14 is a block diagram of an embodiment of a computer system 1400, which may be used, in whole or in part, to provide the functions of a radio frequency (RF) reader (e.g., an RFID reader) as described in the embodiments herein (e.g., RF reader of FIGS. 5, 6, 7A-7C, 8, 9 and 11). It should be noted that FIG. 14 is meant only to provide a generalized illustration of various components, any or all of which may be utilized as appropriate. FIG. 14, therefore, broadly illustrates how individual system elements may be implemented in a relatively separated or relatively more integrated manner. In addition, it can be noted that components illustrated by FIG. 14 can be localized to a single device and/or distributed among various networked devices, which may be disposed at different geographical locations.

The computer system 1400 is shown comprising hardware elements that can be electrically coupled via a bus 1405 (or may otherwise be in communication, as appropriate). The hardware elements may include processor(s) 1410, which may comprise without limitation one or more general-purpose processors, one or more special-purpose processors (such as digital signal processing chips, graphics acceleration processors, and/or the like), and/or other processing structure, which can be configured to perform one or more of the methods described herein. The computer system 1400 also may comprise one or more input devices 1415, which may comprise without limitation a mouse, a keyboard, a camera, a microphone, and/or the like; and one or more output devices 1420, which may comprise without limitation a display device, a printer, and/or the like.

The computer system 1400 may further include (and/or be in communication with) one or more non-transitory storage devices 1425, which can comprise, without limitation, local and/or network accessible storage, and/or may comprise, without limitation, a disk drive, a drive array, an optical storage device, a solid-state storage device, such as a RAM and/or ROM, which can be programmable, flash-updateable, and/or the like. Such storage devices may be configured to implement any appropriate data stores, including without limitation, various file systems, database structures, and/or the like. Such data stores may include database(s) and/or other data structures used store and administer messages and/or other information to be sent to one or more devices via hubs, as described herein.

The computer system 1400 may also include a communications subsystem 1430, which may comprise wireless communication technologies managed and controlled by a wireless communication interface 1433, a reader interface 1434, as well as wired technologies (such as Ethernet, coaxial communications, universal serial bus (USB), and the like). The wireless communication interface 1433 may comprise one or more wireless transceivers that may send and receive wireless signals 1455 (e.g., signals according to 5G NR or LTE) via wireless antenna(s) 1450. The reader interface 1434 may be coupled to the wireless antenna(s) 1450 to send and receive RF signals. Thus the communications subsystem 1430 may comprise a modem, a network card (wireless or wired), an infrared communication device, a wireless communication device, and/or a chipset, and/or the like, which may enable the computer system 1400 to communicate on any or all of the communication networks described herein to any device on the respective network, including a User Equipment (UE), base stations and/or other TRPs, an RF device (e.g., RFID tag), and/or any other electronic devices described herein. Hence, the communications subsystem 1430 may be used to receive and send data as described in the embodiments herein.

In many embodiments, the computer system 1400 will further comprise a working memory 1435, which may comprise a RAM or ROM device, as described above. Software elements, shown as being located within the working memory 1435, may comprise an operating system 1440, device drivers, executable libraries, and/or other code, such as one or more applications 1445, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a non-transitory computer-readable storage medium, such as the storage device(s) 1425 described above. In some cases, the storage medium might be incorporated within a computer system, such as computer system 1400. In other embodiments, the storage medium might be separate from a computer system (e.g., a removable medium, such as an optical disc), and/or provided in an installation package, such that the storage medium can be used to program, configure, and/or adapt a general purpose computer with the instructions/code stored thereon. These instructions might take the form of executable code, which is executable by the computer system 1400 and/or might take the form of source and/or installable code, which, upon compilation and/or installation on the computer system 1400 (e.g., using any of a variety of generally available compilers, installation programs, compression/decompression utilities, etc.), then takes the form of executable code.

It will be apparent to those skilled in the art that substantial variations may be made in accordance with specific requirements. For example, customized hardware might also be used and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium” as used herein, refer to any storage medium that participates in providing data that causes a machine to operate in a specific fashion. In embodiments provided hereinabove, various machine-readable media might be involved in providing instructions/code to processors and/or other device(s) for execution. Additionally or alternatively, the machine-readable media might be used to store and/or carry such instructions/code. In many implementations, a computer-readable medium is a physical and/or tangible storage medium. Such a medium may take many forms, including but not limited to, non-volatile media and volatile media. Common forms of computer-readable media include, for example, magnetic and/or optical media, any other physical medium with patterns of holes, a RAM, a programmable ROM (PROM), erasable PROM (EPROM), a FLASH-EPROM, any other memory chip or cartridge, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus many of the elements are examples that do not limit the scope of the disclosure to those specific examples.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussion utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this Specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Terms, “and” and “or” as used herein, may include a variety of meanings that also is expected to depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AA, AAB, AABBCCC, etc.

Having described several embodiments, various modifications, alternative constructions, and equivalents may be used without departing from the scope of the disclosure. For example, the above elements may merely be a component of a larger system, wherein other rules may take precedence over or otherwise modify the application of the various embodiments. Also, a number of steps may be undertaken before, during, or after the above elements are considered. Accordingly, the above description does not limit the scope of the disclosure.

In view of this description embodiments may include different combinations of features. Implementation examples are described in the following numbered clauses:

Clause 1. A method of determining a position of a radio frequency (RF) device within a wireless network, the method comprising: receiving, at a first wireless device of the wireless network, a first positioning assist request from an RF reader configured to exchange data with the RF device; based on a determination to provide positioning assistance to the RF reader, conducting positioning of the RF device, the positioning of the RF device comprising: sending a second positioning assist request to a second wireless device of the wireless network, locating positioning resources, or a combination thereof; and based on the conducted positioning of the RF device, sending position information associated with the RF device to the RF reader.

Clause 2. The method of clause 1, wherein the RF device comprises a passive RF device without an internal power source, and the RF reader is further configured to receive data with the RF device through backscattered RF signals.

Clause 3. The method of any one of clauses 1-2 wherein the RF device comprises an active RF device with an internal power source, and the active RF device is configured to send signals to the RF reader.

Clause 4. The method of any one of clauses 1-3 wherein the position information associated with the RF device comprises a distance of the RF device to the RF reader, a position of the RF device, information relating to a location of an assistance wireless device, or a combination thereof.

Clause 5. The method of any one of clauses 1-4 wherein the received first positioning assist request comprises information relating to a location of the RF reader; and the determination to provide positioning assistance to the RF reader is based at least on the information relating to the location of the RF reader, a location of the first wireless device, a previously known location of the RF device, or a combination thereof.

Clause 6. The method of any one of clauses 1-5 wherein the information relating to the location of the RF reader comprises a zone identifier of the RF reader when the positioning assist request was sent by the RF reader.

Clause 7. The method of any one of clauses 1-6 wherein the received first positioning assist request comprises information relating to: a list of wireless devices authorized to conduct the positioning of the RF device, the list of wireless devices comprising the first wireless device of the wireless network; communication resources for sending, to the RF reader, feedback relating to determination to provide positioning assistance to the RF reader; identification information of the RF device; a method of the conducted positioning of the RF device; a threshold for a speed of the first wireless device of the wireless network; a speed of the RF reader; information relating to expected time of the positioning; or a combination thereof.

Clause 8. The method of any one of clauses 1-7 wherein the determination to provide positioning assistance to the RF reader is based at least on a speed of the first wireless device of the wireless network, a speed of the RF reader, or a combination thereof.

Clause 9. The method of any one of clauses 1-8 wherein the second positioning assist request comprises information relating to: communication resources for sending, to the second wireless device, feedback relating to determination to provide positioning assistance to the RF reader; identification information of the RF device; a method of the conducted positioning of the RF device; a threshold for a speed of the first wireless device of the wireless network; a speed of the RF reader; information relating to expected time of the positioning; or a combination thereof.

Clause 10. The method of any one of clauses 1-9 wherein the first wireless device of the wireless network comprises a first base station or a first user equipment (UE); and the second wireless device of the wireless network comprises a second UE configured for data communication with the first base station or a second base station configured for data communication with the first UE.

Clause 11. The method of any one of clauses 1-10 wherein a method of the conducted positioning of the RF device comprises Time Difference of Arrival (TDOA)-based positioning or Phase Difference of Arrival (PDOA)-based positioning.

Clause 12. A wireless device within a wireless network, the wireless device comprising: one or more transceivers configured to communicate with a radio frequency (RF) reader and an RF device, the RF reader configured to exchange data with the RF device; memory; and one or more processors communicatively coupled to the one or more transceivers and the memory, and configured to: receive a first positioning assist request from the RF reader; based on a determination to provide positioning assistance to the RF reader, conduct positioning of the RF device, the positioning of the RF device comprising: sending a second positioning assist request to another wireless device of the wireless network, locating positioning resources, or a combination thereof; and based on the conducted positioning of the RF device, send position information associated with the RF device to the RF reader.

Clause 13. The wireless device of clause 12, wherein the RF device comprises a passive RF device without an internal power source, and the RF reader is further configured to receive data with the RF device through backscattered RF signals.

Clause 14. The wireless device of any one of clauses 12-13 wherein the RF device comprises an active RF device with an internal power source, and the active RF device is configured to send signals to the RF reader.

Clause 15. The wireless device of any one of clauses 12-14 wherein the position information associated with the RF device comprises a distance of the RF device to the RF reader, a position of the RF device, information relating to a location of an assistance wireless device, or a combination thereof.

Clause 16. The wireless device of any one of clauses 12-15 wherein the received first positioning assist request comprises information relating to a location of the RF reader; and the determination to provide positioning assistance to the RF reader is based at least on the information relating to the location of the RF reader, a location of the wireless device, a previously known location of the RF device, or a combination thereof.

Clause 17. The wireless device of any one of clauses 12-16 wherein the information relating to the location of the RF reader comprises a zone identifier of the RF reader when the positioning assist request was sent by the RF reader.

Clause 18. The wireless device of any one of clauses 12-17 wherein the received first positioning assist request comprises information relating to: a list of wireless devices authorized to conduct the positioning of the RF device, the list of wireless devices comprising the wireless device within the wireless network; communication resources for sending, to the RF reader, feedback relating to determination to provide positioning assistance to the RF reader; identification information of the RF device; a method of the conducted positioning of the RF device; a threshold for a speed of the wireless device within the wireless network; a speed of the RF reader; information relating to expected time of the positioning; or a combination thereof.

Clause 19. The wireless device of any one of clauses 12-18 wherein the determination to provide positioning assistance to the RF reader is based at least on a speed of the wireless device within the wireless network, a speed of the RF reader, or a combination thereof.

Clause 20. The wireless device of any one of clauses 12-19 wherein the second positioning assist request comprises information relating to: communication resources for sending, to the another wireless device, feedback relating to determination to provide positioning assistance to the RF reader; identification information of the RF device; a method of the conducted positioning of the RF device; a threshold for a speed of the wireless device within the wireless network; a speed of the RF reader; information relating to expected time of the positioning; or a combination thereof.

Clause 21. The wireless device of any one of clauses 12-20 wherein the wireless device comprises a first base station or a first user equipment (UE); and the another wireless device of the wireless network comprises a second UE configured for data communication with the first base station or a second base station configured for data communication with the first UE.

Clause 22. The wireless device of any one of clauses 12-21 wherein a method of the conducted positioning of the RF device comprises Time Difference of Arrival (TDOA)-based positioning or Phase Difference of Arrival (PDOA)-based positioning.

Clause 23. A method of determining a position of a radio frequency (RF) device within a wireless network, the method comprising: at an RF reader configured to receive data from the RF device: configuring a positioning assist request relating to the RF reader, a wireless device of the wireless network, the RF device, or a combination thereof; sending the positioning assist request to the wireless device of the wireless network; and receiving location information associated with the RF device from the wireless device based on the positioning assist request.

Clause 24. The method of clause 23, wherein the RF reader is further configured to exchange data with the RF device through RF signals backscattered from the RF reader, or receive signals sent by the RF device to the RF reader.

Clause 25. The method of any one of clauses 23-24 wherein the positioning assist request comprises: information relating to a location of the RF reader; a list of wireless devices authorized to conduct the positioning of the RF device, the list of wireless devices comprising the wireless device of the wireless network; identification information of the RF device; a method of positioning of the RF device to be conducted by the wireless device of the wireless network; a threshold for a speed of the wireless device of the wireless network; a speed of the RF reader; information relating to expected time of the positioning; or a combination thereof.

Clause 26. The method of any one of clauses 23-25 wherein the location information associated with the RF device comprises a distance of the RF device, an estimated position of the RF device, or a combination thereof.

Clause 27. A radio frequency (RF) reader comprising: one or more transceivers configured to communicate with an RF device; memory; and one or more processors communicatively coupled to the one or more transceivers and the memory, and configured to: configure a positioning assist request relating to the RF reader, a wireless device of a wireless network, the RF device, or a combination thereof; send the positioning assist request to the wireless device of the wireless network; and receive location information associated with the RF device from the wireless device based on the positioning assist request.

Clause 28. The RF device of clause 27, wherein the RF reader is further configured to exchange data with the RF device through RF signals backscattered from the RF reader, or receive signals sent by the RF device to the RF reader.

Clause 29. The RF device of any one of clauses 27-28 wherein the positioning assist request comprises: information relating to a location of the RF reader; a list of wireless devices authorized to conduct the positioning of the RF device, the list of wireless devices comprising the wireless device of the wireless network; identification information of the RF device; a method of positioning of the RF device to be conducted by the wireless device of the wireless network; a threshold for a speed of the wireless device of the wireless network; a speed of the RF reader; information relating to expected time of the positioning; or a combination thereof.

Clause 30. The RF device of any one of clauses 27-29 wherein the location information associated with the RF device comprises a distance of the RF device, an estimated position of the RF device, or a combination thereof.

1. A method of determining a position of a radio frequency (RF) device within a wireless network, the method comprising:
receiving, at a first wireless device of the wireless network, a first positioning assist request from an RF reader configured to exchange data with the RF device;
based on a determination to provide positioning assistance to the RF reader, conducting positioning of the RF device, the positioning of the RF device comprising: sending a second positioning assist request to a second wireless device of the wireless network, locating positioning resources, or a combination thereof; and
based on the conducted positioning of the RF device, sending position information associated with the RF device to the RF reader.

2. The method of claim 1, wherein the RF device comprises a passive RF device without an internal power source, and the RF reader is further configured to receive data with the RF device through backscattered RF signals.

3. The method of claim 1, wherein the RF device comprises an active RF device with an internal power source, and the active RF device is configured to send signals to the RF reader.

4. The method of claim 1, wherein the position information associated with the RF device comprises a distance of the RF device to the RF reader, a position of the RF device, information relating to a location of an assistance wireless device, or a combination thereof.

5. The method of claim 1, wherein:
the received first positioning assist request comprises information relating to a location of the RF reader, and
the determination to provide positioning assistance to the RF reader is based at least on the information relating to the location of the RF reader, a location of the first wireless device, a previously known location of the RF device, or a combination thereof.

6. The method of claim 5, wherein the information relating to the location of the RF reader comprises a zone identifier of the RF reader when the positioning assist request was sent by the RF reader.

7. The method of claim 1, wherein the received first positioning assist request comprises information relating to:
a list of wireless devices authorized to conduct the positioning of the RF device, the list of wireless devices comprising the first wireless device of the wireless network;
communication resources for sending, to the RF reader, feedback relating to determination to provide positioning assistance to the RF reader;
identification information of the RF device;
a method of the conducted positioning of the RF device;
a threshold for a speed of the first wireless device of the wireless network;
a speed of the RF reader;
information relating to expected time of the positioning; or
a combination thereof.

8. The method of claim 1, wherein the determination to provide positioning assistance to the RF reader is based at least on a speed of the first wireless device of the wireless network, a speed of the RF reader, or a combination thereof.

9. The method of claim 1, wherein the second positioning assist request comprises information relating to:
communication resources for sending, to the second wireless device, feedback relating to determination to provide positioning assistance to the RF reader;
identification information of the RF device;
a method of the conducted positioning of the RF device;
a threshold for a speed of the first wireless device of the wireless network;
a speed of the RF reader;
information relating to expected time of the positioning; or
a combination thereof.

10. (canceled)

11. The method of claim 1, wherein a method of the conducted positioning of the RF device comprises Time Difference of Arrival (TDOA)-based positioning or Phase Difference of Arrival (PDOA)-based positioning.

12. A wireless device within a wireless network, the wireless device comprising:
one or more transceivers configured to communicate with a radio frequency (RF) reader and an RF device, the RF reader configured to exchange data with the RF device;
memory; and
one or more processors communicatively coupled to the one or more transceivers and the memory, and configured to:
receive a first positioning assist request from the RF reader;
based on a determination to provide positioning assistance to the RF reader, conduct positioning of the RF device, the positioning of the RF device comprising: sending a second positioning assist request to another wireless device of the wireless network, locating positioning resources, or a combination thereof; and
based on the conducted positioning of the RF device, send position information associated with the RF device to the RF reader.

13. The wireless device of claim 12, wherein the RF device comprises a passive RF device without an internal power source, and the RF reader is further configured to receive data with the RF device through backscattered RF signals.

14. The wireless device of claim 12, wherein the RF device comprises an active RF device with an internal power source, and the active RF device is configured to send signals to the RF reader.

15-17. (canceled)

18. The wireless device of claim 12, wherein the received first positioning assist request comprises information relating to:
a list of wireless devices authorized to conduct the positioning of the RF device, the list of wireless devices comprising the wireless device within the wireless network;
communication resources for sending, to the RF reader, feedback relating to determination to provide positioning assistance to the RF reader, identification information of the RF device;
a method of the conducted positioning of the RF device;
a threshold for a speed of the wireless device within the wireless network;
a speed of the RF reader;
information relating to expected time of the positioning; or
a combination thereof.

19. (canceled)

20. The wireless device of claim 12, wherein the second positioning assist request comprises information relating to:
communication resources for sending, to the another wireless device, feedback relating to determination to provide positioning assistance to the RF reader;
identification information of the RF device;
a method of the conducted positioning of the RF device;
a threshold for a speed of the wireless device within the wireless network;
a speed of the RF reader;
information relating to expected time of the positioning; or
a combination thereof.

21. The wireless device of claim 12, wherein:
the wireless device comprises a first base station or a first user equipment (UE); and
the another wireless device of the wireless network comprises a second UE configured for data communication with the first base station or a second base station configured for data communication with the first UE.

22. (canceled)

23. A method of determining a position of a radio frequency (RF) device within a wireless network, the method comprising:
at an RF reader configured to receive data from the RF device:
configuring a positioning assist request relating to the RF reader, a wireless device of the wireless network, the RF device, or a combination thereof;
sending the positioning assist request to the wireless device of the wireless network; and
receiving location information associated with the RF device from the wireless device based on the positioning assist request.

24. The method of claim 23, wherein the RF reader is further configured to exchange data with the RF device through RF signals backscattered from the RF reader, or receive signals sent by the RF device to the RF reader.

25. The method of claim 23, wherein the positioning assist request comprises:
information relating to a location of the RF reader;
a list of wireless devices authorized to conduct the positioning of the RF device, the list of wireless devices comprising the wireless device of the wireless network;
identification information of the RF device;
a method of positioning of the RF device to be conducted by the wireless device of the wireless network,
a threshold for a speed of the wireless device of the wireless network;
a speed of the RF reader,
information relating to expected time of the positioning; or a combination thereof.

26. The method of claim 23, wherein the location information associated with the RF device comprises a distance of the RF device, an estimated position of the RF device, or a combination thereof.

27-30. (canceled)
